(19) United States
(12) Patent Application Publication
(10) Pub. No.: US 2010/0170593 A1
(43) Pub. Date: Jul. 8, 2010

(54) OXIDATION RESISTANT ALLOY COATING FILM, METHOD OF PRODUCING AN OXIDATION RESISTANT ALLOY COATING FILM, AND HEAT RESISTANT METAL MEMBER

(75) Inventors: Toshio Narita, Hokkaido (JP); Takumi Nishimoto, Hokkaido (JP); Takayuki Yoshioka, Hokkaido (JP)

Correspondence Address: MOORE & VAN ALLEN PLLC, P.O. BOX 13706, Research Triangle Park, NC, 27709, US

(73) Assignee: Toshio Narita, Hokkaldo (JP)

(21) Appl. No.: 12/523,275

(22) PCT Filed: Jan. 11, 2008
(86) PCT No.: PCT/JP2008/050655

§ 371 Date: Nov. 23, 2009

(30) Foreign Application Priority Data
Jan. 15, 2007 (JP) 2007-005926

(51) Int. Cl. C23C 8/00; B32B 15/04

(52) U.S. Cl. 148/240; 148/400

(57) ABSTRACT

A metal substrate is embedded in a diffusion and penetration processing agent containing metal oxide, active metal and catalytic compound and heat treatment is carried out, so that an oxidation resistant alloy coating film containing the metal constituting the metal oxide and the active metal is produced. Al₂O₃, Cr₂O₃, SiO₂ or the like are used as the metal oxide, Hf, Zr, Y, Ti, La, Ce, Mg, Ca or the like are used as the active metal, and NH4Cl, NH4F, HCl, NaCl, NaF or the like are used as the catalytic compound. The metal substrate is Ni, Ni-based alloy, Fe-based alloy, and Co-based alloy. Heat treatment is carried out, for example, at a temperature of 700˜1340° C. for 1 minute˜25 hours in an atmosphere of inert gas or hydrogen gas.

### TECHNICAL FIELD

The present invention relates to an oxidation resistant alloy coating film, a method of producing an oxidation resistant alloy coating film and heat resistant metal members that are suitable for application to various high temperature apparatus members.

### BACKGROUND ART

In apparatuses or members used in jet engines, gas turbines, combustors, chemical plants, petrochemical facilities, vehicles, ironworks, their consumption by oxidation and corrosion are proceeding in high temperature and corrosion environment, which deteriorates the function of apparatus as well as inducing destruction of members and apparatuses. For this, in general, oxidation resistant and corrosion resistant coating films are often formed on the surface of apparatuses and members used in high temperature and corrosion environment.

Various kinds of films are used as oxidation resistant alloy coating films. The methods of producing films are a diffusion coating and an overlay coating. The diffusion coating, which is also called pack cementation, is a method to diffuse and penetrate Al, Cr, Si or the like on substrate surfaces. The overlay coating is a method to overlay alloy particles of MCrAlY (M=Ni, Co, Fe) or nickel aluminide on substrate surfaces by solution spraying or electron beam evaporation.

Details of diffusion coating are stated here. To diffuse and penetrate Al on the substrate surface may be the so-called “aluminizing”, to diffuse and penetrate Cr on the substrate surface may be the so-called “chromizing,” and to diffuse and penetrate Si on the substrate surface may be the so-called “siliconizing”. Hereafter these diffusion and penetration methods are totally stated as diffusion coating.

The diffusion coating is the general term of the methods, which diffuses and penetrates Al, Cr, Si or the like on the substrate surface, and changes the substrate surface layers to an alloy layer rich in these elements. The diffusion coating is conducted for steel materials, stainless steel, Ni-based heat-resistant alloy, Co-based heat-resistant alloy, and applied to turbines, boilers, combustors, oil refinery apparatus, materials for vehicles, and many other materials used in high temperature corrosion environment (see Handbook of Metal Corrosion Protection Technology, pp. 424˜447 issued in 1972 by Shinnihon Printing Inc. (Literature 1)).

The Al diffusion coating has commercial names such as calorizing or calorize and Alityrunk (see Handbook of Metal Surface Technology, pp. 1380˜1396 issued in 1966 by The Nikkan Kogyo Shimbun, Ltd. (Literature 2)).

According to calorizing, a mixture of Al powder and a small amount of NH₄Cl added to it and a metal substrate are placed in rotating retort, then heated in neutral atmosphere at 850˜950° C. for 4˜6 hours. Further, after taking out the metal substrate from the retort, diffusion treatment may be carried out for the metal substrate at 800˜1000° C. for 12˜48 hours.

Alityrunk is the so-called pack method in which diffusion and penetration processing agent and the object to be treated are filled in a furnace, and heated at the temperature higher than 900° C., thereby diffusing and penetrating Al to the object (see Handbook of Metal, pp. 922˜923 Table 13.30, issued in 1990 by Maruzen Co., Ltd. (Literature 3) and Handbook of Metal Surface Technology, pp. 1390 Table 17.66, issued in 1966 by The Nikkan Kogyo Shimbun, Ltd. (Literature 4)). For example, an agent containing FeAl (Al source) 60 weight %, NH₄Cl (catalytic compound) 5 weight %, Al₂O₃ 25 weight %, MgCl₂ 5 weight %, and MgF₂ 5 weight % is used as diffusion and penetration processing agent. Furthermore, there is another method in which a mixture of powder of Fe-50Al alloy (Al source) and NH₄Cl (catalytic compound) are used as diffusion and penetration processing agent. The method is widely used due to its handiness and low cost. NH₄F, NaF, NaCl, NaI or the like can be used instead of NH₄Cl as catalytic compound (see B. K. Gupta and L. L. Seigle; THE EFFECT ON THE KINETICS OF PACK ALUMINIZATION OF VARYING THE ACTIVATOR, Thin Solid Films, 73 (1980), 365˜371 (Literature 5)).

In these Al diffusion coatings, Al contained in oxidation resistant alloy coating film formed by the method mentioned above, is selectively oxidized, thus protective oxide scale (Al₂O₃ scale) is formed, which protect the substrate in high temperature corrosion environment. Therefore, a sufficient amount of Al to selectively form protective Al₂O₃ scale is added in the oxidation resistant alloy coating film, and, in general, the concentration of Al contained in the oxidation resistant alloy coating film is designed considerably higher value than the Al concentration of the substrate.

However, the oxidation resistant alloy coating film formed by the above methods shows following phenomena in high temperature corrosion environment.

(1) Using in high temperature, Al₂O₃ scale is formed by selective oxidation of Al contained in the oxidation resistant alloy coating film, and Al poor layer, of which concentration falls, is formed on the surface of the oxidation resistant alloy coating film. On the other hand, interdiffusion between the oxidation resistant alloy coating film and the substrate proceeds, and Al contained in the oxidation resistant alloy coating film diffuses into the substrate. As the result, the alloy elements contained in the substrate diffuse into the oxidation resistant alloy coating film side, and composition and structure of the oxidation resistant alloy coating film change, so the oxidation resistant capability deteriorates. Both forming of Al poor layer and interdiffusion lose forming ability of protective Al₂O₃ scale. Accordingly, the oxidation resistant alloy coating film loses its function.

(2) The interdiffusion with the substrate varies elements, concentration and texture of the oxidation resistant alloy coating film as well as deteriorates mechanical characteristics of the substrate. Especially, in case where the substrate is Ni-based superalloy, it is widely known that topologically close-packed phase (TCP) is formed, by this, the mechanical characteristics (creep, fatigue) is seriously deteriorated (see Y. Aoki, M. Arai, M. Hosoya, S. Masaki, Y Koizumi, T. Kobayashi, Engine Rotor Application, Status and Perspective, Report of the 123^{rd} Committee on Heat Resisting Materials and Alloys, Japan Society for Promotion of Science, 43, No. 3 (2002), 257˜264 (Literature 6)).

As explained above, the substrate is protected from high temperature corrosion environment by corrosion protection action of protective Al₂O₃ scale formed by selective oxidation of Al contained in oxidation resistant alloy coating film. However, when substrate deformation (including creep and fatigue phenomena in high temperature) occurs by applying mechanical load to the substrate on which oxidation resistant alloy coating film is formed, and when heat stress occurred in heating and cooling overlaps, cracks occur on protective Al₂O₃ scale, which lead peeling.

As such when cracks and peel occur on protective Al₂O₃ scale, Al poor layer formed on the oxidation resistant alloy coating film is directly exposed to high temperature corrosion environment. At this moment, non-protective oxide such as NiAl₂O₄, NiO, NiCr₂O₄ or the like are also formed on the surface of Al poor layer besides protective oxide Al₂O₃. For this, the oxide formed on the surface of Al poor layer does not work as protective oxide scale, which invite deterioration of the oxidation resistant alloy coating film, then induce substrate destruction as well.

Accordingly, it is very important to secure adhesion of protective oxide scale for the oxidation resistant alloy coating film and to prevent from peeling of protective oxide scale.

Until now, the methods to improve adhesiveness of protective oxide scale to the oxidation resistant alloy coating film have been searched for many years.

At present, it is widely known that addition of suitable quantity of elements belonging to rare earth elements or Lantanoid (Lantanide), such as active elements of Hf, Zr, Y, La, Ce, Ti or the like is effective to improve adhesiveness of protective oxides scale. These active elements are often added in raw material alloy powder in advance as seen in MCrAlY alloy powder of overlay coating (see Handbook of Corrosion and Corrosion Protection, pp. 466˜470, issued in 2000 by Maruzen Co., Ltd. (Literature 7)).

Following methods are proposed as methods to add Y or Hf to oxidation resistant alloy coating film containing Al by diffusion coating (see specification of U.S. Pat. No. 3,996,021 (Literature 8) and specification of U.S. Pat. No. 5,000,782 (Literature 9)). In Literature 8, a forming method of oxidation resistant alloy coating film using a pack agent (diffusion and penetration processing agent) containing one kind of metal selected from a group containing Fe, Co and Ni, 0.1˜10 weight % Hf and rest Al is disclosed. This oxidation resistant alloy coating film is formed by the pack coating shown below. Following Pack A and Pack B are used as pack agent.

### <Pack A>

Al source: (20˜48) weight % Al-(50˜70) weight % Ti-((0.5˜9) weight % C alloy/4 weight % of total pack agent
Catalytic compound: 0.2 weight % NH₄F
HF source: Hf: 0, 0.2, 0.35, 2.0, 3 weight % (powder) (HfCl₄, or HfF₄ also can be used.)
Inert filler/rest Al₂O₃

### <Pack B>

Al source: Fe-(51˜61) weight % Al Fe₂Al₅+FeAl₃/4 weight % of total pack agent
Catalytic compound: 0.2 weight % NH₄F
   Hf source: Hf: 0, 0.2, 0.35, 2.0, 3 weight % (powder)
Inert filler: rest Al₂O₃

With respect to both Pack A and B, heating temperature is 1038˜1066° C., heating time is 4 hours, and atmosphere is hydrogen.

The heat treatment resulted in forming aluminizing layer, and Hf concentration of inside and surface of the aluminizing layer is 0.1˜10 weight %.

Cycle oxidation tests were carried out at 1150° C.-room temperature. The result was that both pack A and B have contributed to improve the function more than twice compared to those without Hf.

### Embodiment

Substrate: Rene 80
Pack agent:
   Al source (AlTiC 40 weight %)
   Hf source (0.35 weight % Hf powder)
   Catalytic compound (0.2 weight % NH₄F)
   Inert filler (rest Al₂O₃)
Temperature: 1038˜1066° C. Time: 4 hours
Atmosphere: Hydrogen
Result: Composition of coating layer: Ni-20 weight % Cr-20
   weight % Al-5 weight % Hf

Literature 9 discloses the method of forming aluminized layer containing Y on the surface of Ni-based or Co-based superalloy. Literature 9 describes formation of coating layer on the surface of Ni-based or Co-based superalloy using pack agents, that is, a pack agent containing 5˜35 weight %/Ai-Y—X alloy (X═Si, Cr, Co, Ni, Ti, Hf or alloy of these elements), 1˜20 weight %/active agent, rest a material that is not reduced by Y at high temperature, a pack agent containing 5˜35 weight %/Ai-Y—Si alloy, 1˜20 weight %/CoI₂, rest Y₂O₃, a pack agent containing 5˜10 weight %/Al—Y—Si alloy, 5˜10 weight % CoI₂, rest Y₂O₃, or a pack agent containing 5 weight %/Al—Y—Si alloy, 5 weight %/CoI₂, rest Y₂O₃,

Literature 9 also describes use of a pack agent containing (2˜20) weight % Y, (6˜50) weight % Si, rest Al as composition of Al—Y—Si alloy.

Following is the description on inert filler. That is, inert filler should not be reduced by Y. Otherwise, the diffusion of Y to substrate hardly or never takes place. Al₂O₃ is inert filler which is generally used for coating. Al₂O₃ is reduced by Y, so the use of Al₂O₃ leads to form more stable Y₂O₃. Accordingly, the use of Y₂O₃ instead of Al₂O₃ described in Literature is based on the above reason.

As described above, diffusion and penetration processing of Al, Cr, Si or the like is widely used as a handy and low cost formation method of diffusion coating film at present. For example, Al diffusion coating is generally carried out by embedding a metal substrate to be coated in pack agent comprising mixed powder of pure Al or Al contained alloy as Al source, and NH₄Cl as catalytic compound, and Al₂O₃ as inert filler (sinter preventive agent), and carrying out heat treatment at high temperature.

While a method is proposed, that is, a method containing metals such as Hf, Zr, Y, La, Ce or the like to improve adhesiveness of protective oxide scale to coating layer (oxidation resistant alloy coating film) in alloy base in advance, or adding these metals simultaneously with aluminizing by pack cementation (see Literature s 8 and 9, and Japanese Patent Laid-open Publication No. 1996-112532, (Literature 10)).

That is, Literature 10 describes that a coating layer containing Cr 6 weight %, Al 9 weight %, Nb 0.2 weight %, Y 0.1 weight % is obtained by using Cr powder 65 weight %, Al powder 5 weight %, FeNb alloy powder 2 weight %, NiY alloy powder 3 weight %, NH₄Cl powder 2 weight %, rest Al₂O₃ powder as diffusion and penetration processing agent.

Literature 9 describes that a coating containing 20˜35 weight % Al and 0.2˜2 weight % Y can be formed on Ni-based superalloy and Co-based superalloy by using 5˜35 weight % Al—Y—X alloy (X═Si, Cr, Co, Ni, Ti Hf or alloy containing these metals), 1˜20 weight % active agent, rest materials not reduced by Y at high temperature, for example, Y₂O₃ as diffusion and penetration processing agent. Further, it is explained that Al₂O₃ is not used as it is not effective.

Literature 8 describes that a coating layer comprising Ni-20 weight % Cr-20 weight % AI-5 weight % Hf can be obtained by carrying out diffusion and penetration processing in hydrogen atmosphere at 1038˜1066° C. for 4 hours using 40 weight % AlTiC powder, 0.35 weight % Hf powder, 0.2 weight % NH₄F powder, rest Al₂O₃ as diffusion and penetration processing agent. The concentration of Hf existing inside and surface of the coating layer is 0.110 weight % Hf.

It is well known that to form protective Al₂O₃ scale on the surface of oxidation resistant coating alloy film formed by diffusion coating and to effectively maintain adhesiveness of Al₂O₃ scale to oxidation resistant coating alloy film for a long time, it is preferable to control accurately the concentration of Al contained in the oxidation resistant alloy coating film, kinds, concentration and distribution of active metal.

However, conventional forming methods of oxidation resistant coating alloy film disclosed in Literatures 1 to 10 have issues that it is difficult to control the concentration of Al and the concentration of active metal and their distribution.

The thickness of oxidation resistant coating alloy film is generally very thin compared to the substrate thickness, so the amount of Al and active metal contained in oxidation resistant coating alloy film is also limited. It is understood that concentration of each metal as well as its amount is crucial for oxidation resistant coating alloy film.

For example, in case concentration of Al and active metal is set to optimal composition, Al and active metal are consumed by oxidation, the oxidation resistant coating alloy film cannot form protective oxide scale and cannot maintain adhesiveness to oxide scale under long hour oxidation. While, if Al and active metal are added excessively, non-protective oxide scale is formed by proceeding rapid oxidization at the initial stage, which is also a problem.

Accordingly, it is desirable to make reservoir of active metal inside of oxidation resistant coating alloy film and to supply active metal from inside for the consumption of active metal from the surface by oxidation. However, no such ideal oxidation resistant coating alloy film is presented at present.

Therefore, subjects to be solved by this invention are to provide oxidation resistant coating alloy film which can form active metal reservoir inside and can maintain oxidation resistant ability for long time under high temperature and corrosion environment, a method of producing such oxidation resistant coating alloy film by simple process, enabling low cost and high productivity, and a heat resistant metal member applying the oxidation resistant coating alloy film.

Other subjects to be solved by this invention is to provide an oxidation resistant coating alloy film which can do simultaneous addition of more than 2 kinds of active metal, a method of producing such oxidation resistant coating alloy film by simple process, enabling low cost and high productivity, and a heat resistant metal member applying the oxidation resistant coating alloy film.

Above subjects will become apparent by following description.

### DISCLOSURE OF INVENTION

The Inventors of this invention carried out wide range of studies through both experiments and theories for the purpose of solving above-mentioned drawbacks and realizing ideal oxidation resistant alloy coating films. As the result, the Inventors found the forming methods of oxidation resistant alloy coating films based on the novel principle by fundamentally different mechanism from conventional diffusion coating. Results thereof are explained below in detail.

The conventional diffusion coating, for example, the aluminizing uses an agent comprising Al or an alloy containing Al, active metal or an alloy containing active metal, NH₄Cl as catalytic compound, and Al₂O₃ or Y₂O₃ as inert filler as diffusion and penetration processing agent. In this case, Al₂O₃ or Y₂O₃ as inert filler is added for sinter prevention of pack agent, which does not relate to reaction.

In the conventional diffusion coating, the following forming mechanism is proposed. For example, in case using NH₄Cl as catalytic compound, first, the HCl produced by reaction of NH₄Cl═NH₃+HCl react with Al source (for example, Al powder) and active metal source (for example, Hf powder), then AlCl₃ and HfCl₄ are generated following a reaction formula 2Al+6HCl=2AlCl₃+3H₂, Hf+4HCl=HfCl₄+2H₂. These AlCl₃ and HfCl₄ move as gas bodies, precipitate Al and Hf at the surface of a substrate. These Al and Hf diffuse to the substrate, and an aluminized layer containing Hf is produced.

On the other hand, the Inventors of this Invention found an effective diffusion coating method to produce aluminized layer containing Hf on the substrate surface by using, for example, mixed powder of Al₂O₃+Hf+NH₄Cl as a diffusion and penetration processing agent, embedding a metal substrate in the mixed powder, and then carrying out heat treatment at high temperature in argon gas atmosphere. This method is fundamentally different from the conventional diffusion coating in the point that Al₂O₃ powder acts as Al source to produce aluminized layer not only as inert filler.

This novel diffusion coating provides the following production mechanism. That is, HCl generated by reaction of NH₄Cl═NH₃+HCl reacts with Hf, then generates HfCl₄ following reaction formula Hf+4HCl=HfCl₄+2H₂, The HfCl₄ reacts with Al₂O₃, and HfO₂ and AlCl₃ are generated. That is, a formula 3HfCl₄+2Al₂O₃=3HfO₂+4AlCl₃ is made up. These HfCl₄ and AlCl₃ move as gas bodies, and finally aluminized layer containing Hf is produced on the substrate surface.

Moreover, the characteristics of this novel diffusion coating is to enable to contain active metals, for example, Hf with specific concentration in various nickel aluminide phase such as, for example, γ-Ni phase, γ′-Ni₃Al phase, β-NiAl phase, δ-Ni₂Al₃ phase or the like constituting aluminized layer. As explained above, Hf is oxidized and consumed from the surface of coating layer, however, in the aluminized layer produced by this novel diffusion coating, a large amount of Hf can be contained in γ′-Ni₃Al phase. The Hf contained in γ′-Ni₃Al phase is diffused and supplied on the surface. That is, γ′-Ni₃Al serves as a reservoir of Hf, and maintains excellent adhesiveness of protective Al₂O₃ scale for a long time.

As presuming easily from the above forming mechanism, HCl contained atmosphere, for example, H₂+HCl mixed gas instead of NH₄Cl can be used, or other halogen compound, for example, NH₄F, NaCl, NaF or the like also can be used.

Or, other metal oxides instead of Al₂O₃ can be used.

The present invention was devised by above-mentioned careful examination based on the study through both experiments and theories carried out originally by the Inventors.

According to the first aspect of the invention, there is provided a method of producing an oxidation resistant alloy coating film to produce an oxidation resistant alloy coating film on the surface of a metal substrate,

wherein the oxidation resistant alloy coating film is produced by embedding the metal substrate in a diffusion and penetration processing agent containing metal oxide, active metal and catalytic compound and carrying out heat treatment, so that the oxidation resistant alloy coating film contains the metal constituting the metal oxide and the active metal.

According to the second aspect of the invention, there is provided an oxidation resistant alloy coating film produced on the surface of a metal substrate,

wherein the oxidation resistant alloy coating film is produced by embedding the metal substrate in a diffusion and penetration processing agent containing metal oxide, active metal and catalytic compound and carrying out heat treatment, so that the oxidation resistant alloy coating film contains the metal constituting the metal oxide and the active metal.

According to the third aspect of the invention, there is provided a heat resistant metal member with oxidation resistant alloy coating film on the surface of a metal substrate,

the oxidation resistant alloy coating film is produced by embedding said metal substrate in a diffusion and penetration processing agent containing metal oxide, active metal and catalytic compound and carrying out heat treatment, so that the oxidation resistant alloy coating film contains the metal constituting the metal oxide and the active metal.

In the first to third aspects of the invention, the metal oxide is metal oxide which enables to produce protective oxide scale, for example, oxide containing at least one kind of metal selected from the group consisting of Al, Cr and Si, more preferably oxide containing at least one kind of metal oxide selected from the group consisting of Al₂O₃, Cr₂O₃, and SiO₂, but is not limited to the above. The active metal includes at least one kind of metal selected from the group consisting of Hf, Zr, Y, Ti, La, Ce, Mg and Ca, but is not limited to the above. The active metal may further contain at least one kind of metal constituting metal oxide. The catalytic compound contains, for example a halogen compound, for example at least one kind of compound selected from the group consisting of NH₄Cl, NH₄F, MCl, NaCl, and NaF, but is not limited to the above. The diffusion and penetration processing agent can contain materials other than metal oxide, active metal and catalytic compound as long as retarding the diffusion and penetration, if necessary. A typical example of diffusion and penetration processing agent contains at least one kind of metal selected from the group consisting of Hf, Zr, Y, Ti and Mg less than 89 weight % and NH₄Cl 1˜10 weight %, and the rest is Al₂O₃.

The definition of active metal is explained below.

Assume as an example a case where the metal oxide is Al₂O₃ (metal: Al, oxygen: 0), the active metal is Hf, oxide of the active metal is HfO₂, and the catalytic compound is halogen compound, for example NH₄Cl. In this case, following formation mechanism is proposed.

NH₄Cl is thermally decomposed at high temperature. That is

NH₄Cl═NH₃+HCl (1)

The HCl reacts with Hf, and produces HfCl₄ and H₂. That is,

Hf+4HCl═HCl₄+2H₂ (2)

A part of HfCl₄ reacts with Al₂O₃, and produces HfO₂ and AlCl₃. That is,

3HfCl₄+2Al₂O₃=3HfO₂+4AlCl₃ (3)

The rest of HfCl₄ produced by formula (2) and AlCl₃ produced by formula (3) move as gas bodies, and precipitate Hf and Al on the surface of substrate by the following reactions.

HfCl₄+2H₂=4HCl+Hf (4)

2AlCl₃+3H₂=6HCl+2Al (5)

The H₂ shown in formulas (4) and (5) are produced by the reaction of the formula (2).

The Hf and Al produced by the formulas (4) and (5) produce alloy coating films by being alloyed with the metal constituting the metal substrate.

Hf and Al are alloyed with the metal constituting the metal substrate, by this the formulas of (4) and (5) proceed to right side. That is, it is important to be alloyed. Otherwise, inverse reaction occurs, which makes it return to the previous stage. By the above example, aluminized layer containing Hf is produced.

HCl produced in the formula (1) is consumed by the reaction of formula (2), and HCl is produced by the formulas (4) and (5). Accordingly, the amount of NH₄Cl does not change before and after the reaction. This is the reason the NH₄Cl is called a catalytic compound.

The judgment, whether the metal (Al in above reaction) constituting metal oxide is able to produce an alloy coating film on the surface of a metal substrate, is decided whether the reaction given by the formula (3) is able to proceed right side.

Expressing the judgment based on the thermodynamics, the change of Gibbs's generation free energy for the reaction in the formula (3) is negative.

As already explained, in the conventional Al diffusion and penetration processing and pack processing, the Al₂O₃ does not relate to reaction and is added as sintering prevention agent (inert filler). Al powder or Al contained alloy is used as a supply source of Al.

For this, in the examples shown by the reactions by formulas (1) to (5), Hf reacts with Al₂O₃ via reaction of halogen compound which is catalytic compound, resulting in that Al of Al₂O₃ diffuses to metal substrate side in gas body as halide and produces alloy coating film. In this reaction, Hf is called active metal. In general, the Al₂O₃ is considered as very stable and does no relate to the reaction. Because the stable Al₂O₃ is changed to AlCl₃ by Hf (HfCl₄ by the above example), it is decided that Hf is called as active metal. Therefore, the definition of this active metal is not the only one, and in case of the reaction with Al₂O₃, as an example shown in the formula (3), when the reaction thermodynamically proceeds to right side, it is defined as active metal.

More generally, when halogen compound is used as catalytic compound, the producing mechanism of an oxidation resistant alloy coating film is proposed as follows.

The halogen compound is thermally decomposed at high temperature, and the decomposed product reacts with active metal, and produces a halide of the active metal or the like. A part of this halide reacts with metal oxide, and produces oxide of the active metal and halide of metal consisting of the metal oxide. In the reaction of the production of the oxide of the active metal and the halide of the metal constituting the metal oxide, the change of Gibbs's generation free energy is negative. The oxide of the active metal and the halide of the metal constituting the metal oxide produced by above method moves as gas body, and is decomposed on the surface of the metal substrate, and active metal and metal constituting the metal oxide are precipitated. These metals are alloyed with metal constituting the metal substrate, then an oxidation resistant alloy coating film is produced.

The heat treatment, in general, is carried out at the higher temperature than thermal decomposition temperature or sublimation temperature of the catalytic compound, and at the lower temperature than the melting point of the metal substrate. The lower limit of the temperature of the heat treatment is targeted about 400° C., the thermal decomposition temperature in case using NH₄Cl or NH₄F as the catalytic compound. In case using NaCl or NaF as the catalytic compound, the temperature is targeted at 800° C., which is a temperature when the sublimation occurs remarkably. The temperature of the heat treatment is, for example, more than 600° C. in case using Ni-based superalloy as the metal substrate, practically more than 700° C. In case producing very thin oxidation resistant alloy coating film, it is desirable to carry out at lower temperature. Typically, the heat treatment is carried out at the temperature of 700˜1340° C. for 1 minute to 25 hours in inert gas or hydrogen gas atmosphere.

The metal substrate is not limited, but is selected properly from the metal substrates which meet the requirements or characteristics depending on usage and function. An elemental metal, for example Ni or various kinds of alloy, more specifically, Ni-based alloy, Ni-based heat resistant alloy, Ni-based superalloy, Ni-based single crystal superalloy, Fe-based heat resistant alloy, Co-based heat resistant alloy are used.

The oxidation resistant alloy coating film according to the first aspect of the invention and the method of producing an oxidation resistant alloy coating film according to the second aspect of the invention can be applied to various members, equipment, apparatuses, or the like instead of an oxidation resistant alloy coating film produced by the conventional diffusion coating.

The heat resistant metal member according to the third aspect of the invention is not limited, but are used, for example, for the members of jet engines or gas turbines, moving blades or stator vanes, combustors, fuel jet nozzles, furnaces, heat exchange pipes, sheaths of thermocouples, electric furnaces, chemical plants, oil refinery facilities, vehicles, engine related members, turbocharger (heat resistant alloy, TiAl system alloy), mufflers, catalytic carriers, ironworks, heat exchange member of boilers or combustion nozzles, mufflers for vehicles, and turbocharger rotors or the like.

### BRIEF DESCRIPTION OF DRAWINGS

FIG. 1 is a schematic drawing showing the results of the embodiment 1 of the invention.

FIG. 2 is a schematic drawing showing the results of the embodiment 2 of the invention.

FIG. 3 is a schematic drawing showing the results of the embodiment 3 of the invention.

FIG. 4 is a schematic drawing showing the results of the embodiment 4 of the invention.

FIG. 5 is a schematic drawing showing the results of the embodiment 5 of the invention.

FIG. 6 is a schematic drawing showing the results of the embodiment 6 of the invention.

FIG. 7 is a schematic drawing showing the results of the embodiment 7 of the invention.

FIGS. 8A and 8B are a scanning electron micrograph and a schematic drawing showing the results of the embodiment 8 of the invention.

FIGS. 9A and 9B are a scanning electron micrograph and a schematic drawing showing the results of the embodiment 9 of the invention.

FIGS. 10A and 10B are a scanning electron micrograph and a schematic drawing showing the results of the embodiment 10 of the invention.

FIGS. 11A and 11B are a scanning electron micrograph and a schematic drawing showing the results of the embodiment 11 of the invention.

FIGS. 12A and 12B are a scanning electron micrograph and a schematic drawing showing the results of the embodiment 11 of the invention.

FIGS. 13A and 13B are a scanning electron micrograph and a schematic drawing showing the results of the embodiment 12 of the invention.

FIGS. 14A and 14B are a scanning electron micrograph and a schematic drawing showing the results of the embodiment 12 of the invention.

FIGS. 15A and 15B are a scanning electron micrograph and a schematic drawing showing the results of the embodiment 12 of the invention.

FIGS. 16A and 16B are a scanning electron micrograph and a schematic drawing showing the results of the embodiment 13 of the invention.

FIGS. 17A and 17B are a scanning electron micrograph and a schematic drawing showing the results of the embodiment 13 of the invention.

FIGS. 18A and 18B are a scanning electron micrograph and a schematic drawing showing the results of the embodiment 13 of the invention.

FIGS. 19A and 19B are a scanning electron micrograph and a schematic drawing showing the results of the embodiment 14 of the invention.

FIGS. 20A and 20B are a scanning electron micrograph and a schematic drawing showing the results of the embodiment 14 of the invention.

FIGS. 21A and 21B are a scanning electron micrograph and a schematic drawing showing the results of the embodiment 15 of the invention.

FIGS. 22A and 22B are a scanning electron micrograph and a schematic drawing showing the results of the embodiment 15 of the invention.

FIGS. 23A and 23B are a scanning electron micrograph and a schematic drawing showing the results of the embodiment 16 of the invention.

FIGS. 24A and 24B are a scanning electron micrograph and a schematic drawing showing the results of the embodiment 17 of the invention.

FIGS. 25A and 25B are a scanning electron micrograph and a schematic drawing showing the results of the embodiment 19 of the invention.

FIGS. 26A and 26B are a scanning electron micrograph and a schematic drawing showing the results of the embodiment 20 of the invention.

FIGS. 27A and 27B are a scanning electron micrograph and a schematic drawing showing the results of the embodiment 21 of the invention.

FIGS. 28A and 28B are a scanning electron micrograph and a schematic drawing showing the results of the embodiment 22 of the invention.

FIGS. 29A and 29B are a scanning electron micrograph and a schematic drawing showing the results of the embodiment 23 of the invention.

FIGS. 30A and 30B are a scanning electron micrograph and a schematic drawing showing the results of the embodiment 24 of the invention.

FIGS. 31A and 31B are a scanning electron micrograph and a schematic drawing showing the results of the embodiment 25 of the invention.

FIGS. 32A and 32B are a scanning electron micrograph and a schematic drawing showing the results of the embodiment 26 of the invention.

FIGS. 33A and 33B are a scanning electron micrograph and a schematic drawing showing the results of the embodiment 27 of the invention.

FIGS. 34A and 34B are a scanning electron micrograph and a schematic drawing showing the results of the embodiment 28 of the invention.

FIGS. 35A and 35B are a scanning electron micrograph and a schematic drawing showing the results of the embodiment 29 of the invention.

FIGS. 36A and 36B are a scanning electron micrograph and a schematic drawing showing the results of the embodiment 30 of the invention.

FIGS. 37A and 37B are a scanning electron micrograph and a schematic drawing showing the results of the embodiment 31 of the invention.

FIGS. 38A and 38B are a scanning electron micrograph and a schematic drawing showing the results of the embodiment 32 of the invention.

### BEST MODE FOR CARRYING OUT THE INVENTION

One embodiment of the present invention is explained below referring to the drawings.

An oxidation resistant alloy coating film according to the embodiment is produced as follows.

First, a metal substrate on which an oxidation resistant alloy coating film is produced is embedded in a diffusion and penetration processing agent containing metal oxide, active metal and catalytic compound. Specifically, for example, a diffusion and penetration processing agent is prepared by uniformly mixing powder metal oxide, powder active metal and powder catalytic compound weighed according to a diffusion and penetration alloy coating film to be produced. Then, the metal substrate and the diffusion and penetration processing agent are placed in a predetermined chamber, for example, a crucible, and the crucible is capped.

Next, the crucible is placed in a predetermined reaction chamber, and heat treatment is carried out by heating at the predetermined temperature, for example, the higher temperature than thermal decomposition temperature or sublimation temperature of catalytic compound, and lower temperature than the melting point of the metal substrate in the atmosphere of for example, inert gas (rare gas or nitrogen gas or the like) or hydrogen gas. By the heat treatment, the metal oxide acts as a vapor source of the metal constituting the metal oxide, and the metal evaporates as halogen compound, and also the active metal evaporates as halogen compound. These metals precipitate on the surface of the metal substrate, and by being alloyed with the metal constituting the metal substrate, an oxidation resistant alloy coating film containing the metal constituting the metal oxide, the active metal and the metal constituting the metal substrate is produced.

The metal substrate is, for example, Ni, Ni-based alloy, Ni-based heat resistant alloy, Ni-based superalloy, Ni-based single crystal superalloy, heat resistant steel, Fe-based heat resistant alloy, Co-based heat resistant alloy or the like. The metal oxide is at least one kind of oxide selected from the group consisting of, for example, Al₂O₃, Cr₂O₃, and SiO₂. The active metal is at least one kind of metal selected from the group consisting of, for example, Hf, Zr, Y, Ti, La, Ce, Mg and Ca. The catalytic compound is, for example, halogen compound, more specifically at least one kind of compound selected from the group consisting of NH₄Cl, NH₄F, HCl, NaCl and NaF.

In case of using Ni as the metal substrate, the oxidation resistant alloy coating film to be obtained comprises at least one phase selected from the group consisting of γ-Ni phase, γ′-Ni₃Al phase, β-NiAl phase, and γ-Ni₂Al₃ phase, for example. The γ-Ni phase contains 0.005 atomic %<(Hf+Zr+Y+Ti+Mg)<1 atomic % and 5 atomic %<Al<15 atomic %. The γ′-Ni₃Al phase contains 0.005 atomic %<(Hf+Zr+Y+Ti+Mg)<10 atomic % and 16 atomic %<Al<27 atomic %. The β-NiAl phase contains 0.005 atomic %<(Hf+Zr+Y+Ti+Mg)<30 atomic % and 30 atomic %<Al<58 atomic %. The δ-Ni₂Al₃ phase contains 0.005 atomic %<(Hf+Zr+Y+Ti+Mg)<3 atomic % and 59 atomic %<Al<62 atomic %. And, (Hf+Zr+Y+Ti+Mg) means a total of one or more kinds of metals selected from the group consisting of Hf, Zr, Y, Ti and Mg. The lower limit 0.005 atomic % of the concentration of above mentioned (Hf+Zr+Y+Ti+Mg) is a detection limit of Electron-Probe Micro Analyzer (EPMA). In case that the metal substrate is an alloy containing Ni and Cr such as Ni-based alloy, Ni-based heat resistant alloy, Ni-based superalloy, Ni-based single crystal superalloy, heat resistant steel, Fe-based heat resistant alloy, Co-based heat resistant alloy or the like, the γ-Ni phase typically further contains 0.1˜45 atomic % Cr, the γ′-Ni₃Al phase further contains 0.1˜7 atomic % Cr, the β-NiAl phase further contains 0.1˜10 atomic % Cr, and the 6-Ni₂Al₃ phase further contains 0.1˜5 atomic % Cr. Further, these γ-Ni phase, γ′-Ni₃Al phase, β-NiAl phase, and δ-Ni₂Al₃ phase may further contain by 0.01˜15 atomic % at least one kind of elements selected from the group consisting of V, Nb, W, Mo, Ta, Pt, Ir, Ru, Co, Fe, Mn and Si by transition of elements from the metal substrate and its environment.

According to the one embodiment, by diffusion and penetration processing, an oxidation resistant alloy coating film containing at least one kind of metal, which enable to produce a protective oxide scale, selected from the group consisting of Al, Cr and Si, and at least one kind of active metal, which enables to improve the adhesiveness of the protective oxide scale, selected from the group consisting of Hf, Zr, Y, Ti, La, Ce, Mg and Ca can be produced by a simple process, which enables to realize low cost and high productivity. Further, these active metals can be added in specific phases composing the oxidation resistant alloy coating film. In this case, the metal which can produce a protective oxide scale is supplied from the metal oxide, so it is not necessary to use an unit or an alloy of the metal as a source of the metal. For example, in producing an oxidation resistant alloy coating film by Al diffusion coating, Al or Al contained alloy is not necessary to use as an Al source like conventional pack cementation does.

The oxidation resistant alloy coating film of the one embodiment can directly produce on the surface of various kinds of metal substrates, and also can produce on the surfaces after carrying out metal plating or overlay coating on the surface of the metal substrate. For example, the oxidation resistant alloy coating film containing Al by Al diffusion coating can produce directly on the surface of various kinds of metal substrates, and also can produce on the surface of the metal substrate after carrying out Ni plating, Ni—Al system or NiCoCrAlY system overlay coating on the surface of the metal substrate. Also in this case, above specific active metals can be contained in phases composing the oxidation resistant alloy coating film. For example, in case of a metal substrate containing Ni or the surface of the metal substrate on which Ni plating is carried out, above specific active metals can be contained in the γ-Ni phase, γ′-Ni₃Al phase, β-NiAl phase, δ-Ni₂Al₃ phase or the like.

Also, by this one embodiment, by using diffusion and penetration processing agent containing pack agent containing multiply more than 2 kinds of active metals, metal oxide and catalytic compound, it is possible to carry out simultaneous addition, which is difficult when these active metals are each an unit. For example, in case of using (Hf+Zr) pack agent (containing Al₂O₃ and NH₄Cl), multiply containing Hf and Zr, it is difficult to add Zr to an aluminized layer by single Zr pack agent (containing Al₂O₃ and NH₄Cl), but it is possible to add Zr and Hf simultaneously.

Also, by this one embodiment, by using a diffusion and penetration processing agent containing pack agent, which contains NaCl as catalytic compound, active metal and metal oxide, the penetration processing at high temperature (for example 1200˜1300°) is possible. For example, in case of a pack agent in which catalytic compound is NH₄Cl, it is difficult to control appropriately the amount of penetration processing because the decomposition (NR₄Cl→NH₃+HCl) of NH₄Cl proceeds rapidly at high temperature. However, NaCl sublimes at high temperature and moves as gas body, and because of low sublimation pressure, the penetration process progresses slowly. Accordingly the amount of penetration can easily be controlled.

Also, for example, when the diffusion coating of the one embodiment applies to a metal substrate composed of Ni, Ni-based alloy, Ni-based superalloy, Ni-based single crystal superalloy and the like, Ni—Cr—Al system γ-Ni phase, γ′-Ni₃Al phase, β-NiAl phase and δ-Ni₂Al₃ phase are produced, and concentration of Hf contained in each phase can be controlled to the above-mentioned concentration range.

Also, by producing various kinds of nickel aluminide layer on the particular position of an oxidation resistant alloy coating film, for example, by producing γ′-Ni₃Al phase in an inner layer, β-NiAl phase in an outer layer of an oxidation resistant alloy coating film, the γ′-Ni₃Al phase of the inner layer acts as a reservoir of Hf.

The oxidation resistant alloy coating film by this one embodiment is superior in high temperature oxidation resistance and high temperature corrosion resistance, and can produce a protective oxide scale superior in adhesiveness for an oxidation resistant alloy coating film, which enables to maintain oxidation resistant capability of the oxidation resistant alloy coating film for a long time.

The effect is explained below taking up one example.

For example, an oxidation resistant alloy coating film is produced by simultaneous diffusion and penetration processing of Al and Hf by the method of one embodiment on a metal substrate composing of Ni-based superalloy. By this, concentration of Hf contained in γ phase, γ′ phase composing Ni-based superalloy, and concentration of Hf contained in each γ-Ni phase, γ′-Ni₃Al phase, β-NiAl phase, and δ-Ni₂Al₃ phase composing newly produced diffusion layer can be controlled to concentration range described above.

In case that the metal substrate on which the oxidation resistant alloy coating film is produced is placed in high temperature oxidation and corrosion environment, Hf is consumed from the oxidation resistant alloy coating film by oxidation, but Hf is continuously supplied from γ′-Ni₃Al phase serving as a reservoir to β-NiAl phase or γ-Ni phase. So, the effect of Hf, that is, the effect of improvement of adhesiveness for the oxidation resistant alloy coating film of protective Al₂O₃ scale produced by oxidation of Al can be maintained for a long time. The protective Al₂O₃ scale can be protected from peeling off from the oxidation resistant alloy coating film.

By producing the oxidation resistant alloy coating film on the surface of a metal substrate according to this one embodiment, a superior heat resistant metal member can be obtained. This heat resistant metal member can be used for, for example, members of jet engines and gas turbines on which this oxidation resistant alloy coating film is produced, moving blades and stator vanes, heat exchange members of combustors and boilers, combustion nozzles, exhaust gas scrubber and mufflers for vehicles, and turbocharger rotors and the like.

Embodiments are Explained.

The method of producing diffusion and penetration processing agent (pack agent) used in the undermentioned embodiment, and manufacturing process of an oxidation resistant alloy coating film are explained in details below.

The pack agent is produced as follows:

The reagent level NH₄Cl powder, Al₂O₃ powder, Hf metal powder (its purity is 98 weight % and it contains 2 weight % Zr as impurity) weighed to predetermined amount are stirred and mixed in a mortar. The composition ratio of these powders is Hf (0.01˜10) weight %, NH₄Cl (1˜10) weight %, the rest is Al₂O₃.

In case of using Cr₂O₃, SiO₂ or the like instead of Al₂O₃, the pack agent can be produced by the method.

In case of using Zr, Y, Ti, Mg, Ca or the like instead of Hf, the pack agent can be produced by the method.

In case of using NaCl, NH₄F, HCl, NaF or the like instead of NH₄Cl, the pack agent can be produced by the method.

A metal substrate (test piece) and pack agent produced by the above method are filled in an alumina crucible and an alumina cap is put on the above.

The alumina crucible filled with the metal substrate and the pack agent is inserted in a horizontal reaction tube. First, operation to evacuate the reaction tube to vacuum at room temperature and introduce Ar gas is repeated several times. After that the crucible is heated to predetermined temperature in Ar gas atmosphere. The heating speed is 10° C./minute. Cooling is carried out in a furnace. The heat treatment is carried out in Ar gas atmosphere at the temperature of 700˜1340° C. for 1 minute to 25 hours.

The heat treated sample was analyzed. According to the concentration analyses of the surface layer of the sample by an element analyzer, it is considered that the concentration is the average of 5˜10 μm depth from the surface judging from penetration depth of X-ray.

The basic composition of the pack agent according to the first example is active metal: 5 weight %, NH₄Cl: 5 weight %, rest: Al₂O₃. Hf pack, Zr pack, Y pack, Ti pack, (Hf+Zr) pack and (Hf+Y) pack are used as pack agent.

The basic composition of the pack agent according to the second example is active metal: 5 weight %, NH₄Cl: 5 weight %, rest: Cr₂O₃. Hf (Cr₂O₃) pack is used as pack agent.

The basic composition of the pack agent according to the third example is active metal: 5 weight %, NH₄Cl: 5 weight %, rest: SiO₂. Hf (SiO₂) pack is used as pack agent.

Ni, Ni-based heat resistant alloy (Hastelloy-X, Hastelloy-C (“Hastelloy” is a registered trademark), INCONEL-625 (“INCONEL” is a registered trademark)), Fe-based alloy (stainless steel, SUS304), Ni-based superalloy Rene' 80 (“Rene” is a registered trademark)), and Ni-based single crystal superalloy (CMSX-4 (“CMSX” is a registered trademark), TMS-82+ (“TMS” is a registered trademark)) are used as a metal substrate. The composition of Hastelloy-X, Hastelloy-C, INCONEL-625, SUS304, Rene' 80, CMSX-4 and TMS-82+ is shown in Table 1 below.

TABLE 1

| Alloy | Hastelloy-X | Hastelloy-C | INCONEL-625 | SUS304 | Rene′ 80 | CMSX-4 | TMS-82+ |
|---|---|---|---|---|---|---|---|
| Element | Composition (atomic %) | | | | | | |
| Al | | | 0.87 | | 6.35 | 12.59 | 12.2 |
| Ni | 48.02 | 60.61 | 59.16 | 68.61 | 58.61 | 63.76 | 66.02 |
| Cr | 23.51 | 18.00 | 24.33 | 19.00 | 15.36 | 7.58 | 5.85 |
| Co | 0.99 | 2.65 | | | 9.20 | 9.26 | 8.22 |
| W | 0.16 | 1.19 | | | 1.24 | 1.98 | 2.94 |
| Fe | 19.81 | 5.59 | 5.27 | 68.61 | | | |
| Ti | | | 0.49 | | 5.96 | 1.27 | 0.65 |
| Mo | 5.46 | 10.12 | 5.52 | | 2.88 | 0.38 | 1.23 |
| Mn | 0.53 | 1.14 | 0.54 | 1.50 | | | |
| Nb | | | 2.28 | | | | |
| C | 0.49 | 0.10 | 0.49 | 0.37 | 0.81 | | |
| Si | 1.04 | 0.18 | 1.05 | 1.17 | | | |
| Ta | | | | | | 2.18 | 2.06 |
| Re | | | | | | 0.98 | 0.8 |
| Zr | | | | | 0.02 | | |
| B | | | | | 0.08 | | |
| Hf | | | | | | 0.034 | 0.035 |

### Example 1

Heating temperature dependency is examined using an Ni plate as a metal substrate, and Hf as active metal and setting heating time to 1 hour.

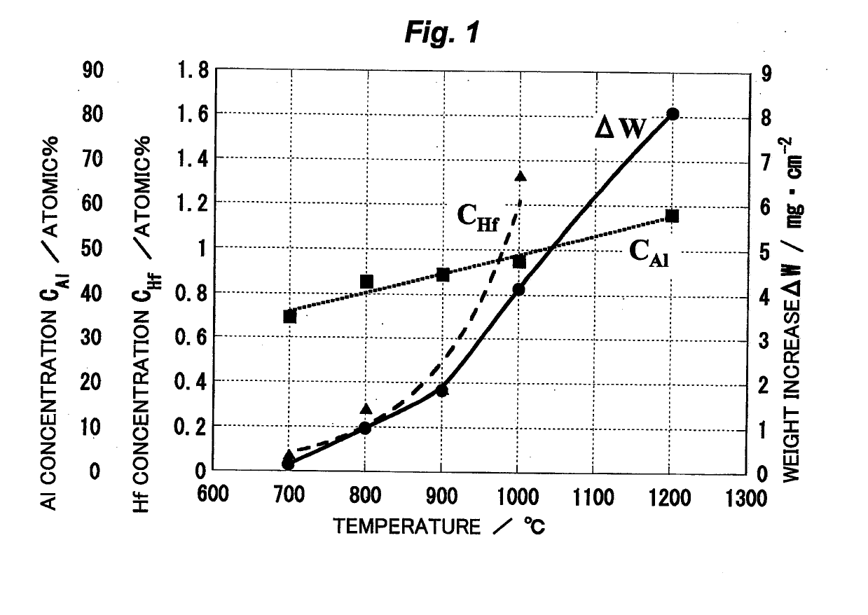

The result is shown in FIG. 1.

As apparent from FIG. 1, the weight increase ΔW increases from 0.2 mg/cm² at 700° C. to 8 mg/cm² at 1200° C., Al concentration C_{Al} increases from 34 atomic % at 700° C. to 58 atomic % at 1200° C., and Hf concentration C_{Hf} increases from 0.07 atomic % at 700° C. to 1.3 atomic % at 1000° C.

Possibility of the surface melting at 1200° C. is high, so the value of C_{Hf} is excluded.

### Example 2

Contained amount of Hf dependency is examined using an Ni plate as a metal substrate, and Hf as active metal and setting heat treatment condition to 1000° C. for 1 hour.

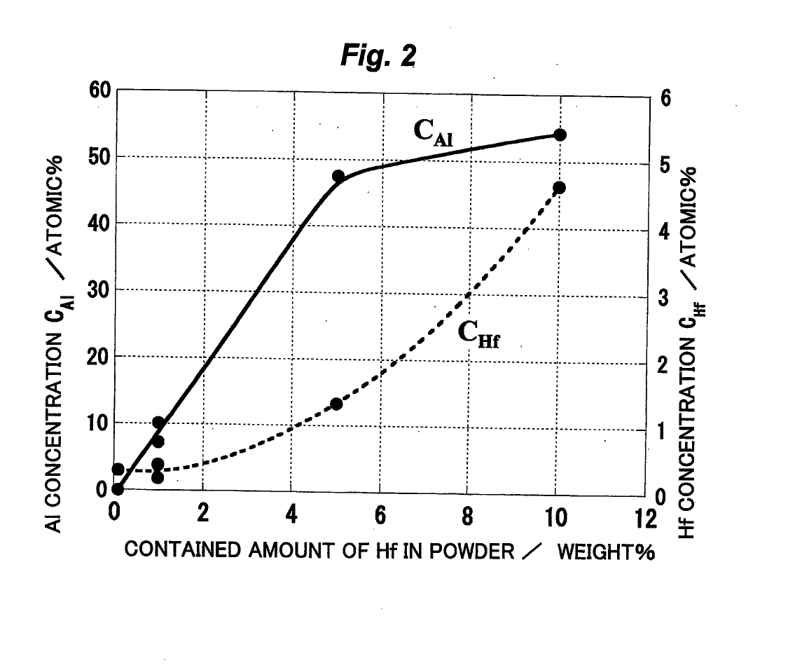

The result is shown in FIG. 2.

As apparent from FIG. 2, Al concentration C_{Al} increases from less than 0.1 atomic %, when contained amount of Hf is 0.1 weight % Hf, to about 47 atomic %, when contained amount of Hf is 5 weight % Hf, and becomes 54 atomic % when contained amount of 1-If is 10 weight % Hf.

Hf concentration C_{Hf} gradually increases from 0.2 atomic %, when contained amount of Hf is 0.1 weight % Hf, to about 4.6 atomic %, when contained amount of Hf is 10 weight % Hf.

### Example 3

Heating temperature dependency is examined using an Ni plate as a metal substrate and Zr or Y (each 5 weight %) as active metal and setting heating time to 1 hour.

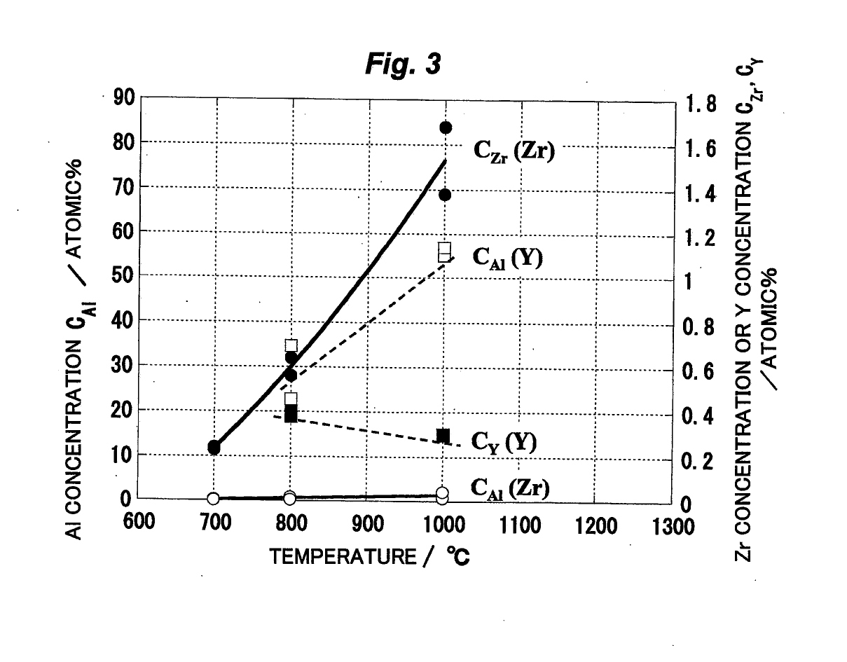

The result is shown in FIG. 3.

As apparent from FIG. 3, in case of Zr pack, Zr concentration C_{Zr} (Zr) increases with temperature rises from 0.22 atomic % at 700° C. to 1.5 atomic % at 1000° C. However, Al concentration C_{Al} (Zr) is negligible amount of 0.01˜0.1 atomic %. In case of Y pack, Y concentration C_{Y} (Y) is in the range of 0.3˜0.4 atomic % at 800˜1000° C. However, Al concentration C_{Al} (Y) increases from 30 atomic % at 800° C. to 55 atomic % at 1000° C.

From the above results, Zr and Y show reverse results.

### Example 4

Heating time dependency (1˜25 hours) is examined using an Ni plate as a metal substrate, Hf, and Zr or Y (each 5 weight %) as active metal and setting heating temperature to 800° C.

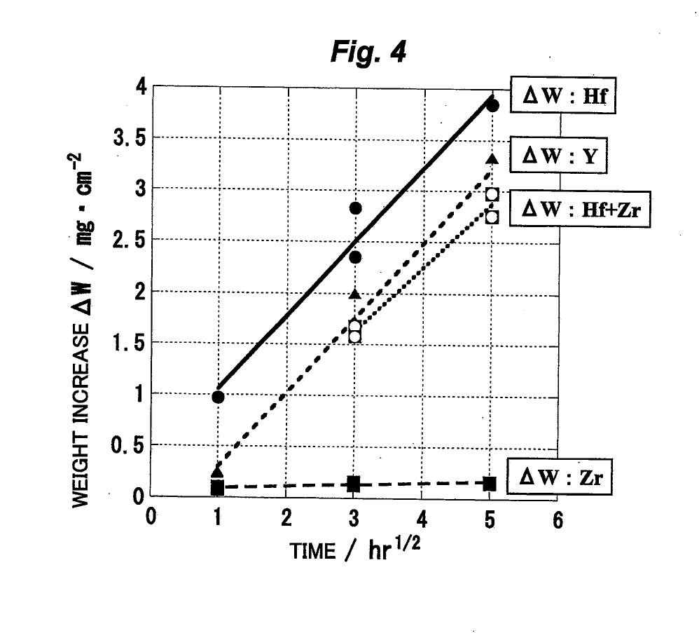

The result is shown in FIG. 4.

As apparent from FIG. 4, in Hf pack, the weight increase (ΔW:Hf) increases in proportion to square root of time from 1 mg/cm² in 1 hour to about 4 mg/cm² in 25 hours. In Y pack, the weight increase (ΔW:Y) increases in proportion to square root of time from 0.2 mg/cm² in 1 hour to about 3.3 mg/cm² in 25 hours. In Zr pack, the weight increase (ΔW:Zr) hardly increases from 0.1 mg/cm² in 1 hour to 0.2 mg/cm² in 25 hours.

In (Hf+Zr) pack to carry out multiple addition of Hf and Zr (5 weight % Hf+5 weight % Zr), the weight increase (ΔW:Hf+Zr) increases from 1.7 m g/cm² in 9 hour to 2.9 mg/cm² in 25 hours.

Comparing with Hf pack, overall weight increase is minor.

### Example 5

Heating time dependency (1˜25 hours) is examined using an Ni plate as a metal substrate and Hf, Zr or Y (each 5 weight %) as active metal and setting heating temperature to 800° C.

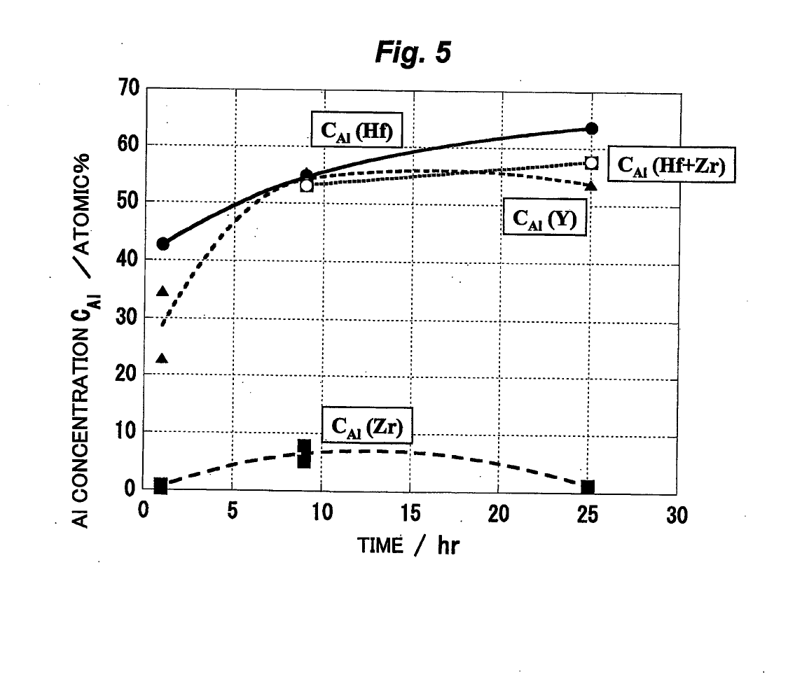

The result is shown in FIG. 5.

As apparent from FIG. 5, in Hf pack, Al concentration C_{Al} (Hf) increases from 42 atomic % in 1 hour to 63 atomic % in 25 hours. In Y pack, Al concentration C_{Al} (Y) increases from 30 atomic % in 1 hour to about 54 atomic % in 9 hours, which is almost constant although there is a little decrease in 25 hours. In Zr pack, Al concentration C_{Al} (Zr) is detection limit in 1 hour, about 7 atomic % is identified in 9 hours, and decreases to negligible amount in 25 hours again. In (Hf+Zr) pack in which combined addition of Hf and Zr (5 weight % Hf+5 weight % Zr) is carried out, Al concentration C_{Al} (Hf+Zr) is about 53 atomic % in 9 hours and 57 atomic % in 25 hours. Compared with Hf single addition, Al concentration is slightly low, but almost the same.

### Example 6

Heating time dependency (1˜25 hours) is examined using an Ni plate as a metal substrate and Hf, Zr or Y (each 5 weight %) as active metal and setting heating temperature to 800° C.

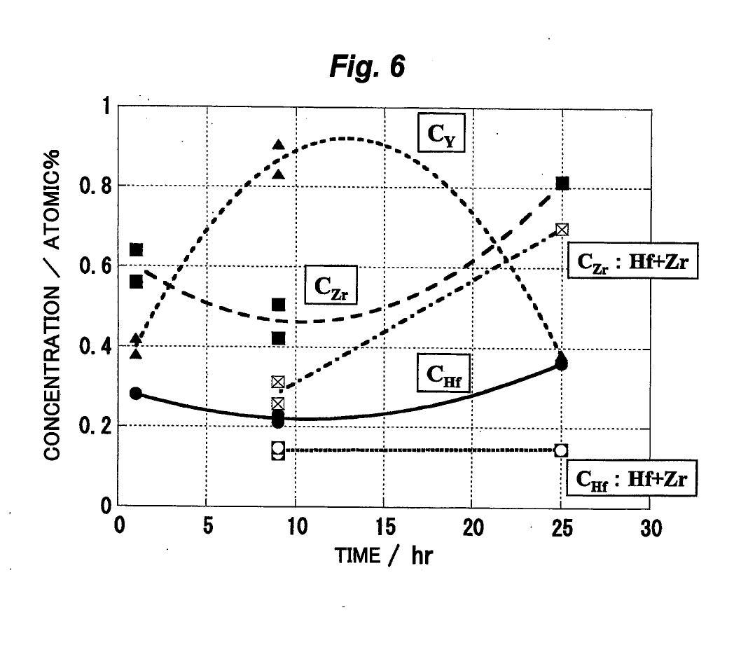

The result is shown in FIG. 6.

As apparent from FIG. 6, in Hf pack, Hf concentration C_{Hf} is almost constant from 0.28 atomic % in 1 hour to 0.36 atomic % in 25 hours. In Y pack, Y concentration C_{Y} increases from 0.4 atomic % in 1 hour to 0.86 atomic % in 9 hours, and decreases to 0.4 atomic % in 25 hours. In Zr pack, Zr concentration C_{Zr} is 0.6 atomic % in 1 hour, and decreases to 0.45 atomic % in 9 hours, then increases to 0.8 atomic % in 25 hours. In (Hf+Zr) pack in which combined addition of Hf and Zr (5 weight % Hf+5 weight % Zr) is carried out, Hf concentration C_{Hf} (Hf+Zr) stays constant 0.15 atomic % in 9˜25 hours, and Zr concentration C_{Zr} (Hf+Zr) increases from 0.3 atomic % in 9 hours to 0.7 atomic % in 25 hours. Compared to Hf (single) or Zr (single) pack, the concentration slightly decreases.

### Example 7

Contained amount of Hf dependency (0.01˜5 weight %) is examined using an Ni plate on which 30 μm thick Ni is plated as a metal substrate, (Hf+Zr) pack as active metal, setting addition amount of Al powder to 0.45 g (total mass of the pack agent is 23 g) and setting heat treatment condition to 800° C. for 9 hours.

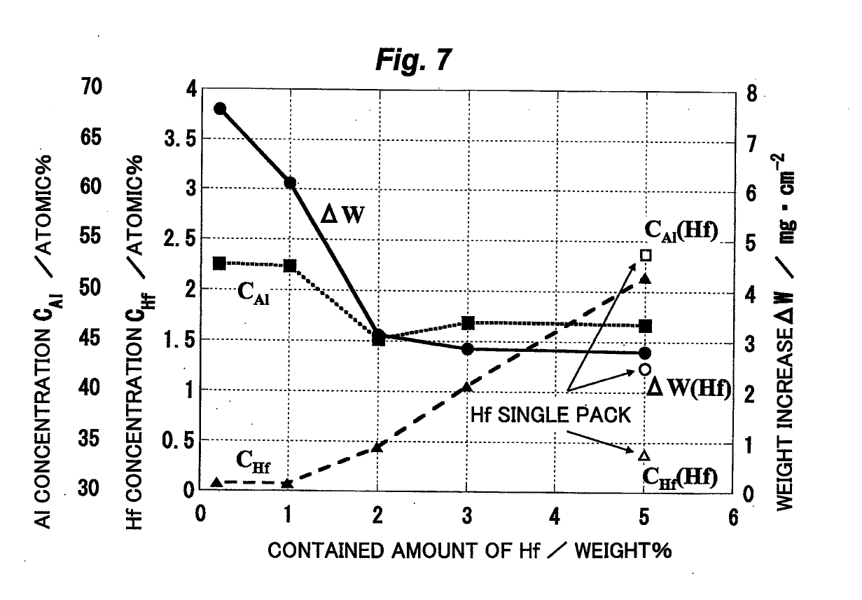

The result is shown in FIG. 7.

As apparent from FIG. 7, the weight increase ΔW is 7.6 mg/cm² when contained amount of Hf is 0.1 weight %, and with the increase of containing amount of Hf, ΔW decreases, about 3 mg/cm² in 2 weight % Hl, which stays constant to 5 weight % Hf. Al concentration C_{Al} is similar to the contained amount of Hf dependency of Hf in above weight increase, when contained amount of Hf is 53 atomic % in 0.1 weight %, with the increase of contained amount of Hf, ΔW decreases, and about 45 atomic % in 2 weight % HE which stays constant to 5 weight % HE Hf concentration C_{Hf} is detection limit when contained amount of Hf is 0.1 weight % and 1 weight %, and increases with the increase of contained amount of Hf, and is 2.1 atomic % in 5 weight % Hf.

Comparison with Hf (Single) Pack (Results in Case of 5 Weight % Hf)

Hf concentration drastically increases to 2.1 atomic % in (Hf+Zr) pack for 0.4 atomic % in Hf pack. Al concentration decreases to 46 atomic % in (Hf+Zr) pack for 54 atomic % in Hf (single) pack. The result proves that Al concentration and Hf concentration can be controlled to different concentration from Hf single pack by combined addition of Hf and Zr. This is a very important result.

### Example 8

Using an Ni plate as a metal substrate, Hf as active metal, heating treatment is carried out at 1000° C. for 1 hour in Ar atmosphere.

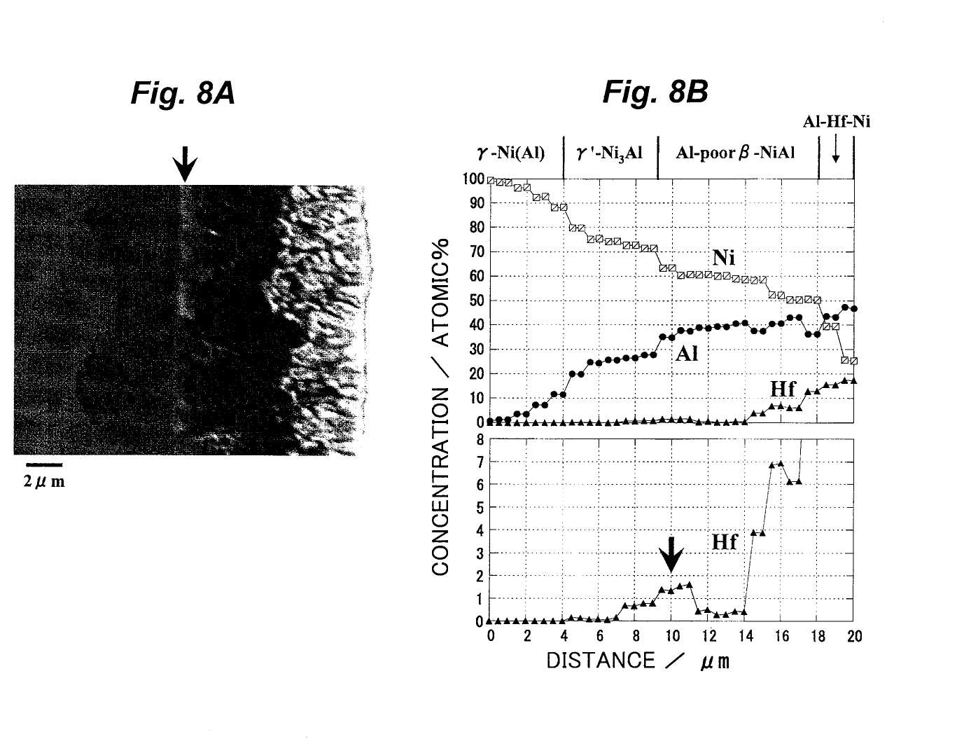

FIG. 8A shows a cross-sectional photograph (scanning electron micrograph, same in the following) of an obtained sample and FIG. 8B shows the result of EPMA analysis.

As apparent from FIG. 8B, Al concentration is about 42 atomic % on the surface, 36 atomic % in about 10 μm depth, then decreases to 28 atomic %, and 20 atomic % in 15 μm depth. Then Al concentration gradually decreases towards the inside of the sample. The whole depth is 18 μm.

The layers of the sample are, from the surface, Al poor β-NiAl phase, γ′-Ni₃Al phase, γ-Ni (Al) phase. Al concentration range of β-NiAl phase exists with 50 atomic % between, and less than 50 atomic % is noted as Al poor β-NiAl phase and more than 50 atomic % is noted as Al rich β-NiAl phase.

Hf concentration is 18 atomic % on the surface, then gradually decreases towards about 5 μm depth, after reaching 0.3 atomic %, gradually increases to 0.8˜4.7 atomic % in 8˜12 μm depth.

Hf of outside of the sample exists in the light part of FIG. 8A, and produces Al—Ni—Hf compound. Hf of inside of the sample exists in slightly light part of FIG. 8A (shown by an arrow), which corresponds from Al poor β-NiAl phase to γ′-Ni₃Al phase.

### Example 9

Using an Ni plate as a metal substrate, Hf as active metal, heating treatment is carried out at 800° C. for 9 hours in Ar atmosphere.

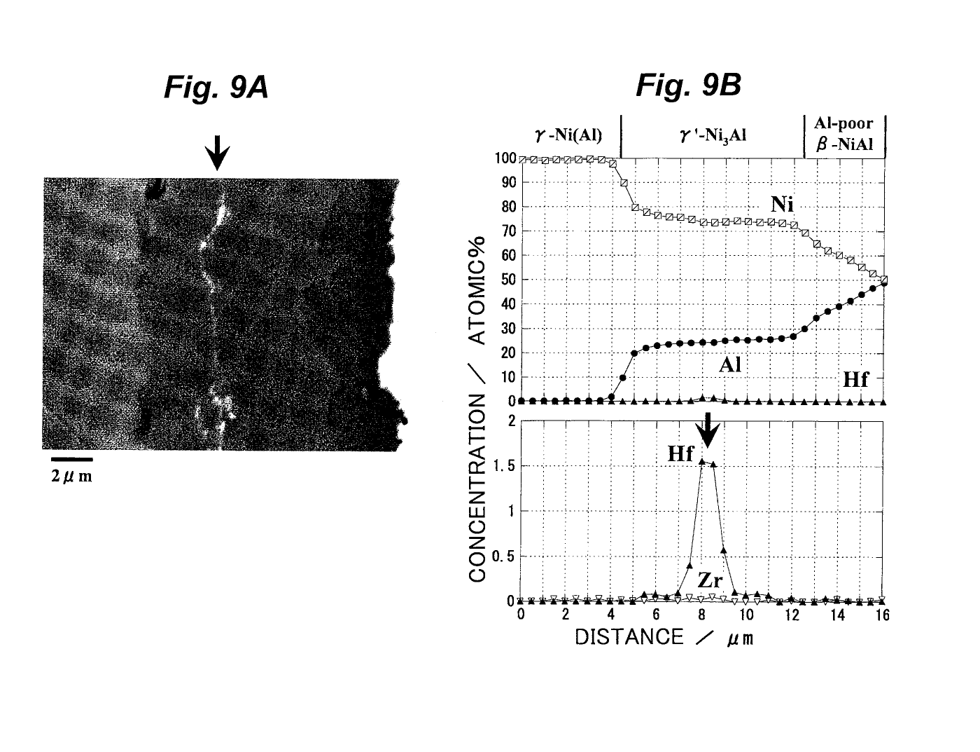

FIG. 9A shows a cross-sectional photograph of an obtained sample and FIG. 9B shows the result of EPMA analysis.

As apparent from FIG. 9B, Al concentration is about 50 atomic % on the surface, 30˜28 atomic % in about 4 μm depth, then gradually decreases, and 20 atomic % in 11 μm depth, then sharply decreases.

The layers of the sample are, from the surface, Al poor β-NiAl phase, γ′-Ni₃Al phase, and γ-Ni (Al) phase.

Regarding Hf concentration, the surface concentration is detect ion limit until about 7 μm depth, increases in 7˜9 μm depth, and Hf concentration is about 1.6 atomic %.

Hf of inside of the sample exists in the slightly light part of FIG. 9A shown by an arrow, which corresponds to inside of γ′-Ni₃Al phase.

Zr concentration shows similar distribution with Hf, and shows about 0.1 atomic % Zr at the point shown by an arrow. Zr is impurity contained in 14f, and is 2 weight %.

### Example 10

Using an Ni plate on which 30 μm thick Ni is plated as a metal substrate, (Hf+Al) pack as active metal, heating treatment is carried out at 1000° C. for 1 hour in Ar atmosphere.

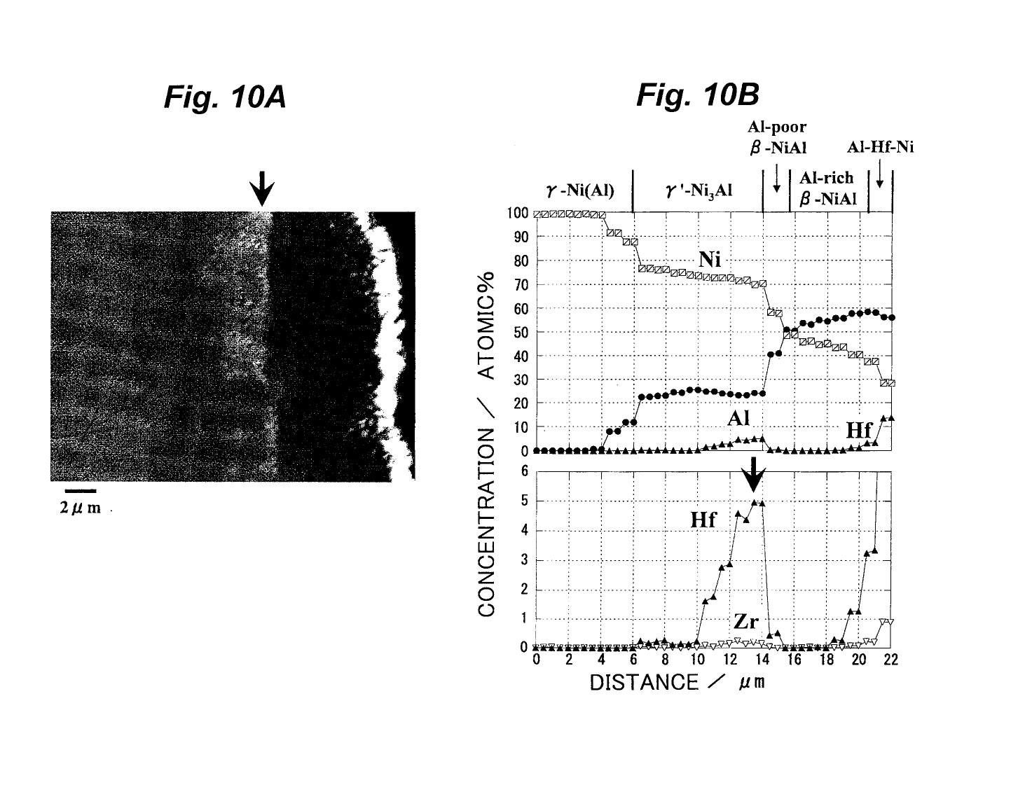

FIG. 10A shows a cross-sectional photograph of an obtained sample, and FIG. 10B shows the result of EPMA analysis.

As apparent from FIG. 10B, Al concentration is about 58 atomic % on the surface, 50 atomic % in about 6 μm depth, then decreases to 25 atomic %, and 22 atomic % in 16 μm depth. Al concentration gradually decreases from 12 atomic % towards the inside of Ni. The whole depth is 18 μm.

The layers of the sample are, from the surface, Al rich β-NiAl phase, Al poor β-NiAl phase, γ′-Ni₃Al phase, γ-Ni (Al) phase.

Regarding Hf concentration, the surface concentration is 13 atomic %, gradually decreases towards about 1 μm depth, after reaching less than 0.1 atomic %, again increases in 8˜12 μm depth showing about 5 atomic %.

Hf of outside of the sample exists in light parts of FIG. 10A and produces Al—Ni—Hf compound. Hf of inside of the sample exists in slightly light parts shown by an arrow, in γ′-Ni₃Al phase adjacent to Al poor β-NiAl phase.

Zr concentration shows similar distribution with Hf, and shows about 0.2 atomic % at the point shown by an arrow. Zr is impurity contained in Hf, and is 2 weight %.

### Example 11

Using an Ni plate on which 30 μm thick Ni is plated as a metal substrate, (Hf+Al) pack as active metal, heat treatment is carried out at 800° C. for 9 hours in Ar atmosphere.

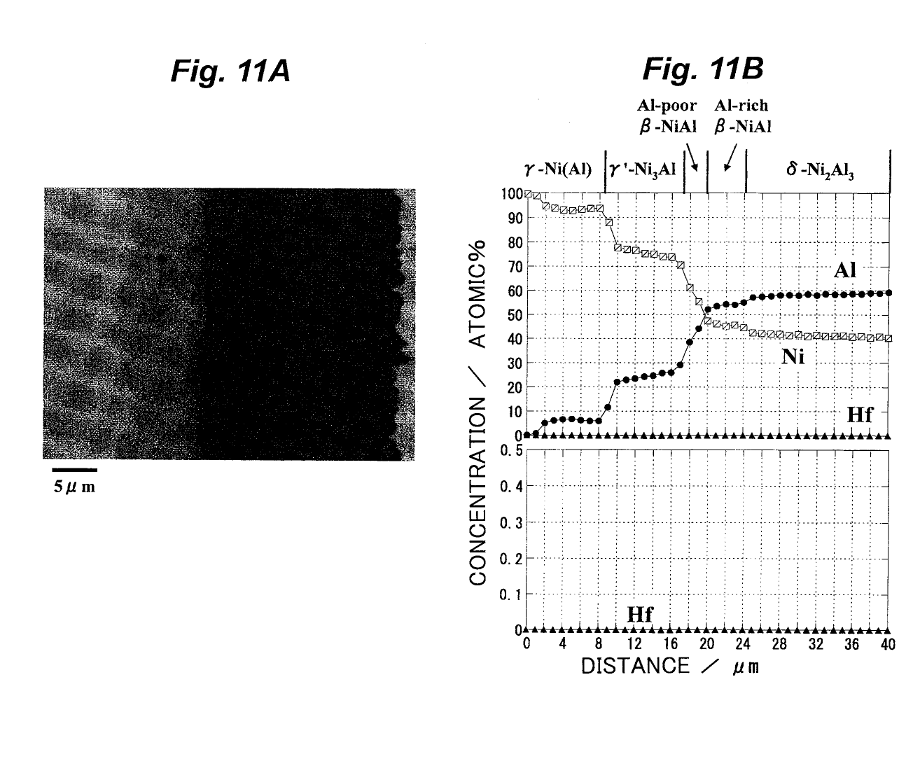

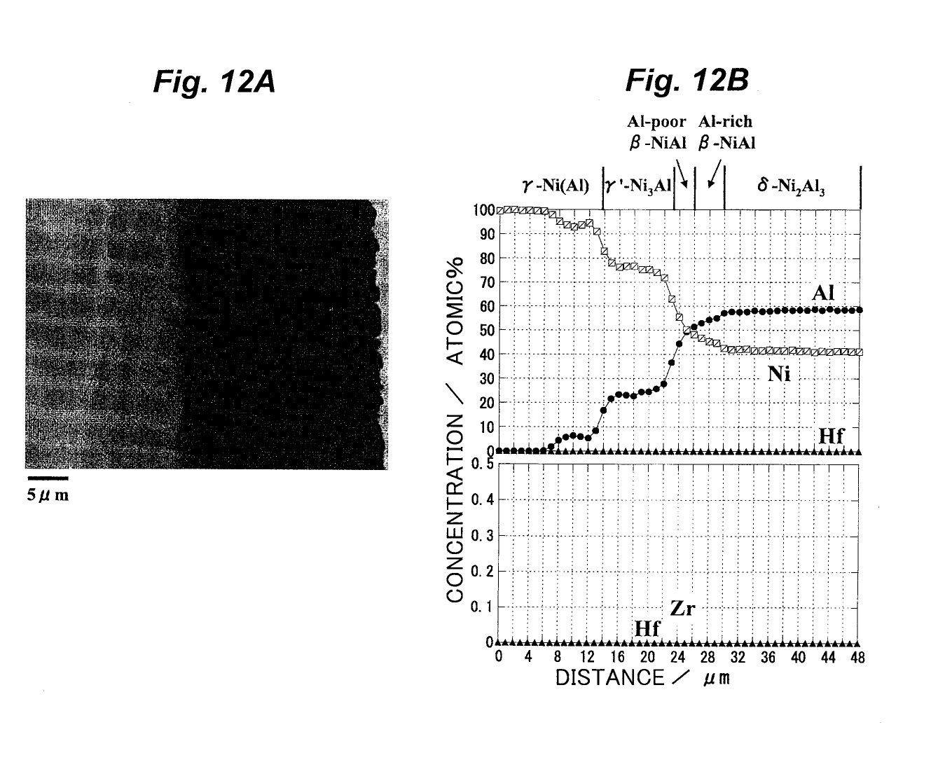

FIG. 11A shows a cross-sectional photograph of an obtained sample in case that the contained amount of Hf is 1 weight %, and FIG. 11B shows the result of EPMA analysis. FIG. 12A is a cross-sectional photograph in case that the contained amount of Hf is 0.2 weight %, and FIG. 12B shows the result of EPMA analysis.

As apparent from FIGS. 11B and 12B, Al concentration is about 60 atomic % on the surface, 50 atomic % in about 20 μm depth, then decreases to 28 atomic %, and 22 atomic % in 31 μm depth. Then Al concentration gradually decreases from 8 atomic % Al towards inside of Ni. The whole depth is 38 p.m.

The layers of the sample are from the surface δ-Ni₂Al₃ phase, Al rich β-NiAl phase, Al poor β-NiAl phase, γ′-Ni₃Al phase, γ-Ni (Al) phase.

Hf concentration is under detection limit over the whole coating layer. In case that high Al concentration S—Ni₂Al₃ phase, and Al rich β-NiAl phase are produced, invasion of 1-If becomes difficult. This fact is a very important result.

### Example 12

Using an Ni plate as a metal substrate and Hf as active metal, heat treatment is carried out at 800° C. for 1 hour, 9 hours, and 25 hours in Ar atmosphere.

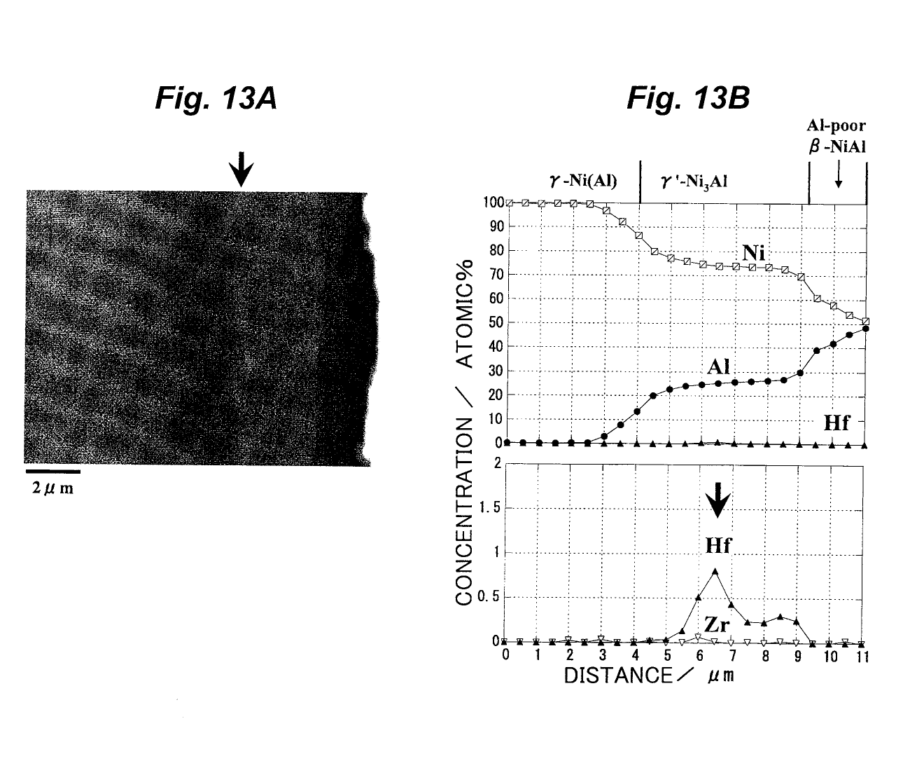

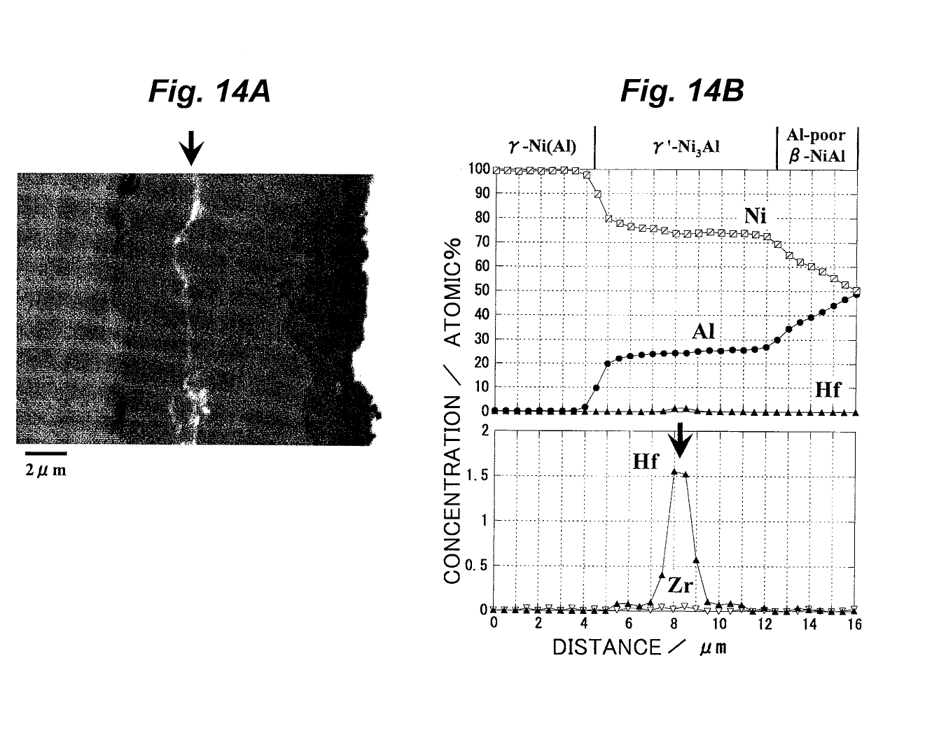

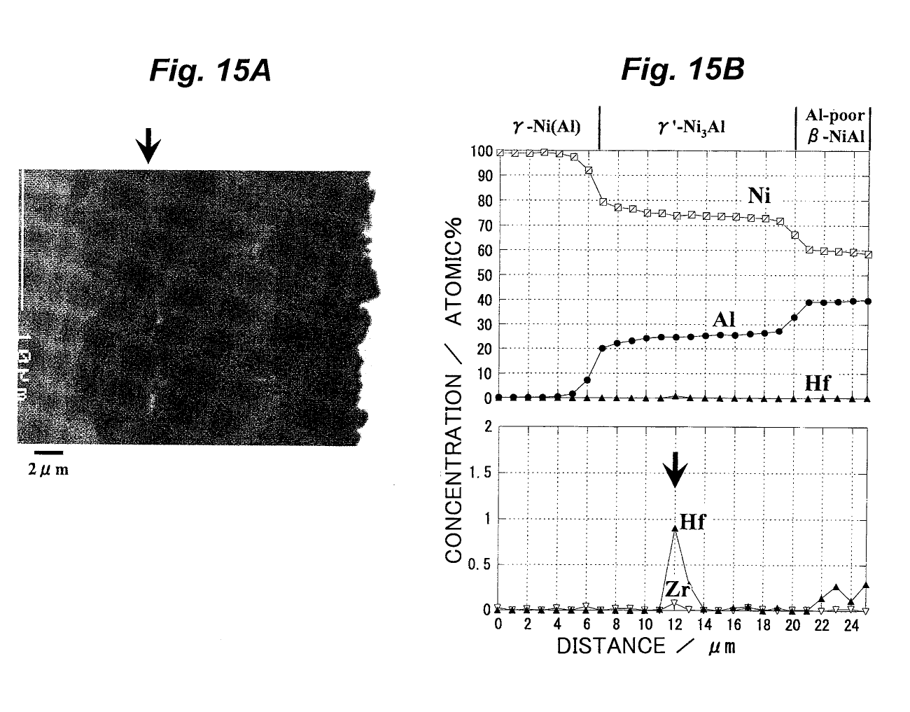

FIG. 13A shows a cross-sectional photograph of an obtained sample in case that the Ni plate is heated at 800° C. for 1 hour using Hf (5 weight %) pack, and FIG. 13B shows the result of EPMA analysis. FIG. 14A shows a cross-sectional photograph of an obtained sample in case that the Ni plate is heated at 800° C. for 9 hours using Hf (5 weight %) pack, and FIG. 14B shows the result of EPMA analysis. FIG. 15A shows a cross-sectional photograph of an obtained sample in case that the Ni plate is heated at 800° C. for 25 hours using Hf (5 weight %) pack, and FIG. 15B shows the result of EPMA analysis.

The thickness of the coating layer of these samples is 8 μm for the sample heated for 1 hour, 12 μm for the sample heated for 9 hours and 19 μm for the sample heated for 25 hours. Outside of the coating layer is Al poor β-NiAl phase, and inside of the coating layer is γ′-Ni₃Al phase and γ-Ni (Al) phase. Al concentration is about 50 atomic % on the surface, after decreasing to about 30 atomic %, gradually decreases to 22 atomic %, and further decreases.

Layers of the samples are, from the surface, Al poor β-NiAl phase, γ′-Ni₃Al phase, and the thickness of γ-Ni (Al) phase is very thin.

Hf exists inside of γ′-Ni₃Al phase of the coating layer (arrow), and the concentration is 0.8 atomic % in case heated 1 hour, 1.6 atomic % in case heated 9 hours, and 0.9 atomic % in case heated 25 hours.

Zr concentration shows similar distribution to Hf, and shows about 0.1 atomic % at the point shown by an arrow. Zr is impurity contained in Hf, and is 2 weight %.

It is very important results that Hf and Zr exist inside of γ′-Ni₃Al phase.

### Example 13

Using an Ni plate as a metal substrate and Zr as active metal, heat treatment is carried out at 800° C. for 1 hour, 9 hours, and 25 hours in Ar atmosphere.

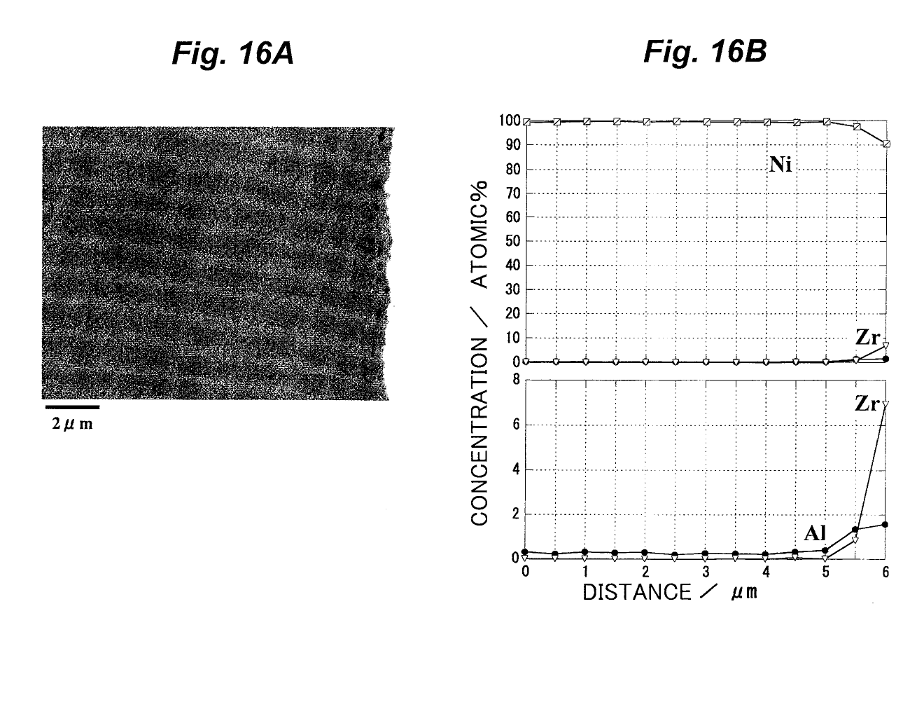

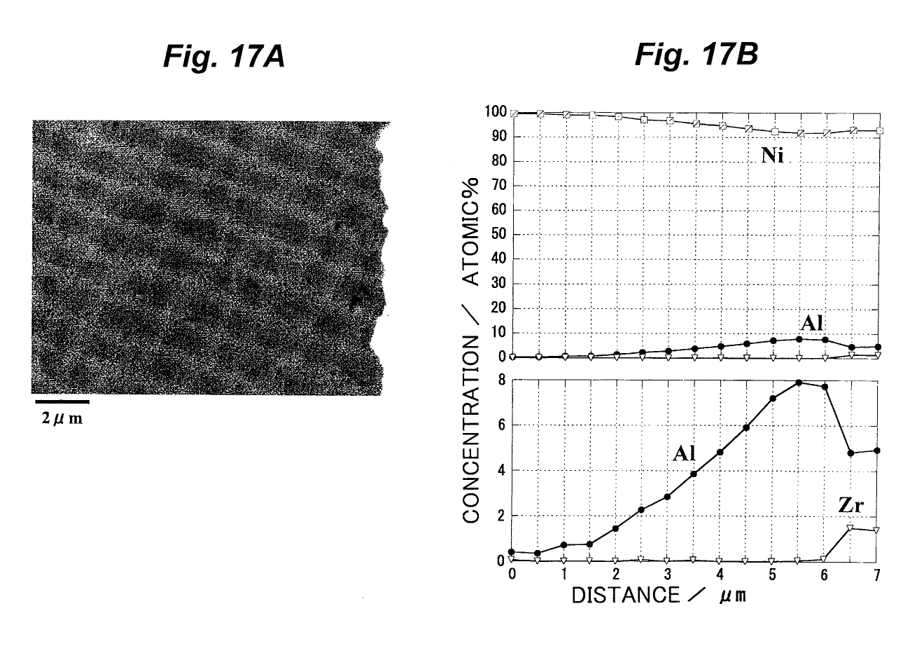

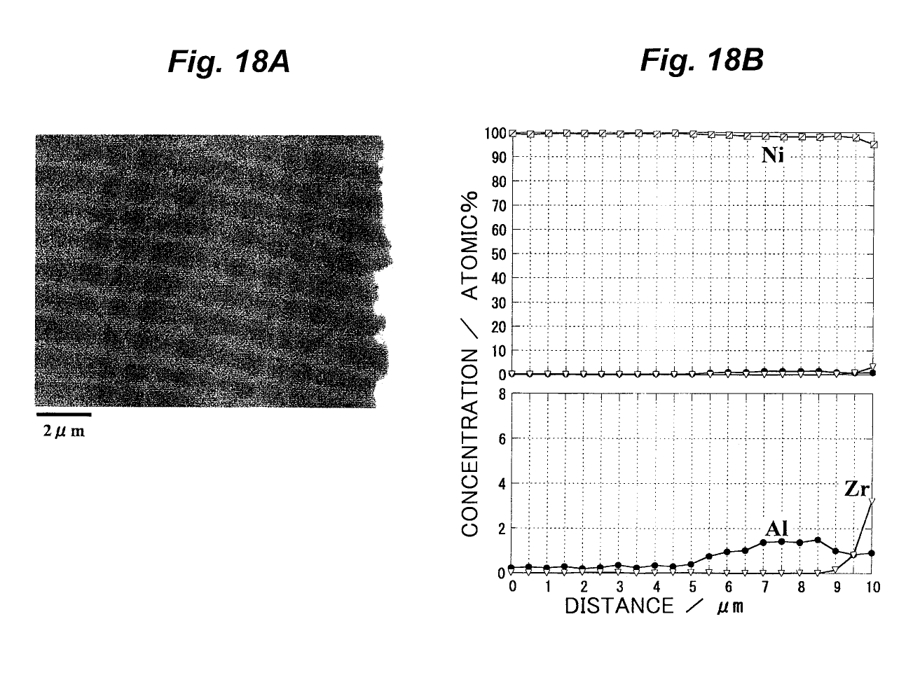

FIG. 16A shows a cross-sectional photograph of an obtained sample in case that the Ni plate is heated at 800° C. for 1 hour using Zr (5 weight %) pack, and FIG. 16B shows the result of EPMA analysis. FIG. 17A is a cross-sectional photograph of an obtained sample in case that the Ni plate is heated at 800° C. for 9 hours using Zr (5 weight %) pack, and FIG. 17B shows the result of EPMA analysis. FIG. 18A shows a cross-sectional photograph of an obtained sample in case that the Ni plate is heated at 800° C. for 25 hours using Zr (5 weight %) pack, and FIG. 18B shows the result of EPMA analysis.

The thickness of the coating layer of these samples is thin in any heating time, and concentration of Al and Zr of the coating layer is low.

Although aluminide coating is possible by Zr pack, the result is not good.

### Example 14

Using an Ni plate as a metal substrate and (Hf+Zr) pack as active metal, heat treatment is carried out at 800° C. for 9 hours, and 25 hours in Ar atmosphere.

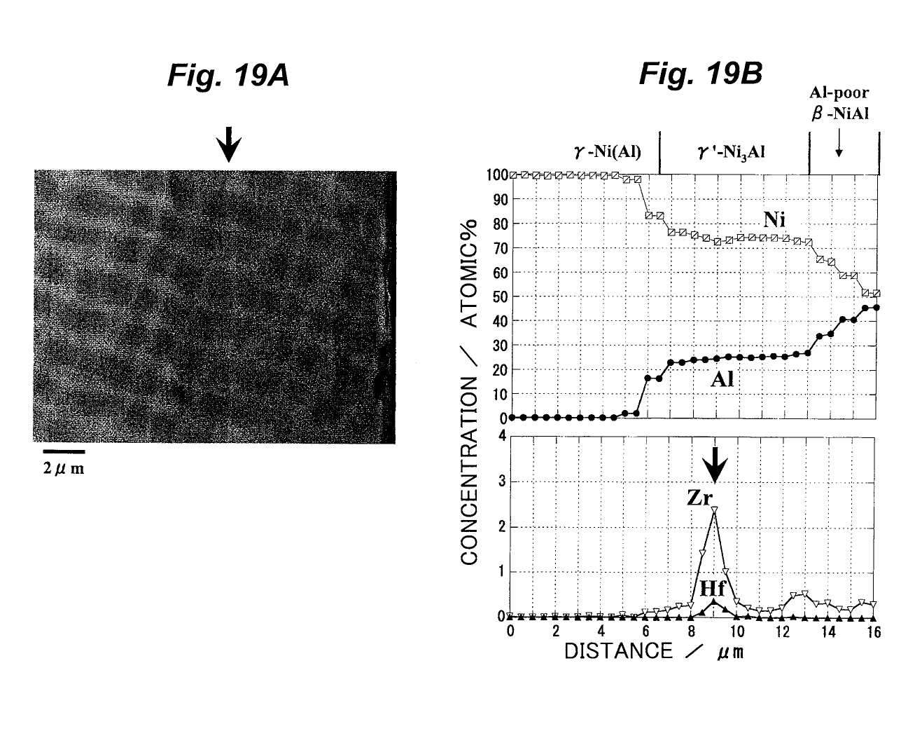

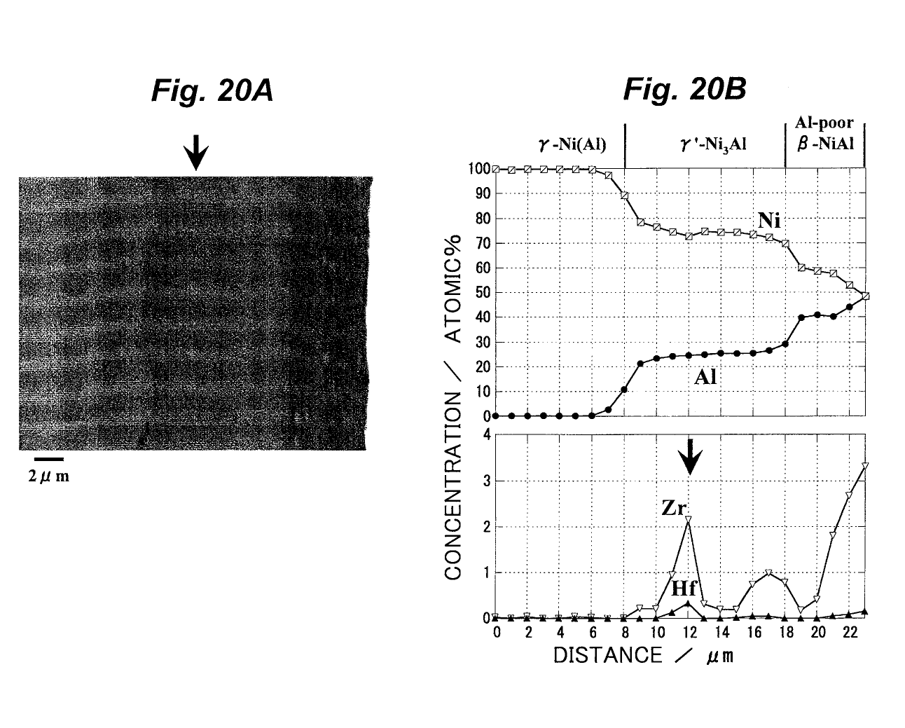

FIG. 19A shows a cross-sectional photograph of an obtained sample in case that the Ni plate is heated at 800° C. for 9 hour using (Hf+Zr) pack (5 weight % Hf+5 weight % Zr), and FIG. 19B shows the result of EPMA analysis. FIG. 20A shows a cross-sectional photograph of an obtained sample in case that the Ni plate is heated at 800° C. for 25 hours using (Hf+Zr) pack (5 weight % Hf+5 weight % Zr), and FIG. 20B shows the result of EPMA analysis.

As apparent from FIGS. 19B and 20B, Al concentration is from about 50 atomic % on the surface to 28 atomic %, remains almost stable, after that again sharply decreases.

Layers of the sample are, from the surface, Al poor β-NiAl phase, γ′-Ni₃Al phase, and γ-Ni (Al) phase.

Regarding Zr concentration, Zr is enriched to 2.5 atomic % inside of γ′-Ni₃Al phase shown (arrow) in 9 hours, in 25 hours Zr is enriched each on the surface and inside shown (arrow), and Zr concentration on the surface is about 3.2 atomic %, and Zr concentration inside is 2.2 atomic %. Regarding Hf concentration, Hf acts the same behavior as Zr does, but Hf concentration is 0.4 atomic % at the point of an arrow drawn inside.

Zr (single) pack is hard to add Zr, while Hf (single) pack is able to add Hf. However, in case of a combined pack of Hf+Zr, Zr is added rather than Hf, which is a very important result.

### Example 15

Using an Ni plate as a metal substrate and Y as active metal, heat treatment is carried out at 800° C. for 9 hours, and 25 hours in Ar atmosphere.

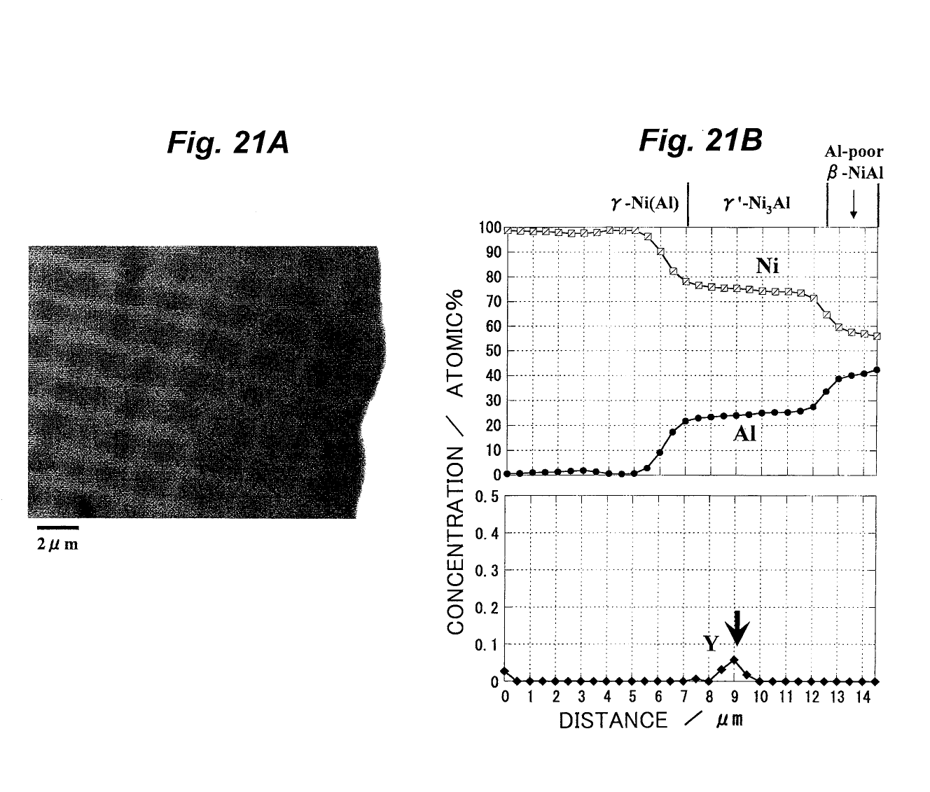

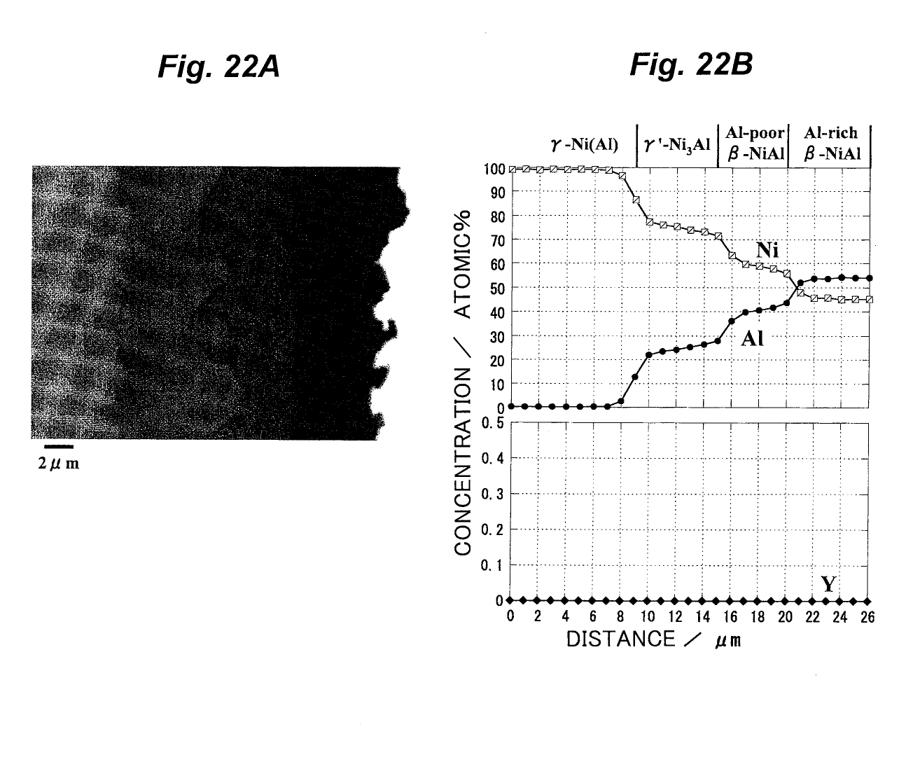

FIG. 21A shows a cross-sectional photograph of an obtained sample in case that the Ni plate is heated at 800° C. for 9 hours using Y (5 weight %) pack, and FIG. 21B shows the result of EPMA analysis. FIG. 22A shows a cross-sectional photograph of an obtained sample, in case that the Ni plate is heated at 800° C. for 25 hours using Y pack (5 weight %), and FIG. 22B shows the result of EPMA analysis.

The thickness of these coating layers of the samples becomes thicker with the increase of heating time, growing from 9.5 μm in 9 hours to 18 μm in 25 hours.

Al concentration on the surface becomes higher with the increase of heating time, growing from 42 atomic % in 9 hours to about 52 atomic % in 25 hours.

Layers of the sample heated for 9 hours are from the surface Al poor β-NiAl phase, γ′-Ni₃Al phase, and γ-Ni (Al) phase.

Layers of the sample heated for 25 hours are, from the surface, Al rich β-NiAl phase, Al poor β-NiAl phase, γ′-Ni₃Al phase, and γ-Ni (Al) phase.

Regarding Y concentration, 0.06 atomic % is observed inside of γ′-Ni₃Al phase as shown by an arrow in FIG. 21B. However, as shown in FIG. 22B, Y concentration is detection limit over the whole coating layer when Al rich β-NiAl phase is produced on the surface.

### Example 16

Using an Ni plate as a metal substrate and (Hf+Y) pack as active metal, heat treatment is carried out at 800° C. for 9 hours in Ar atmosphere.

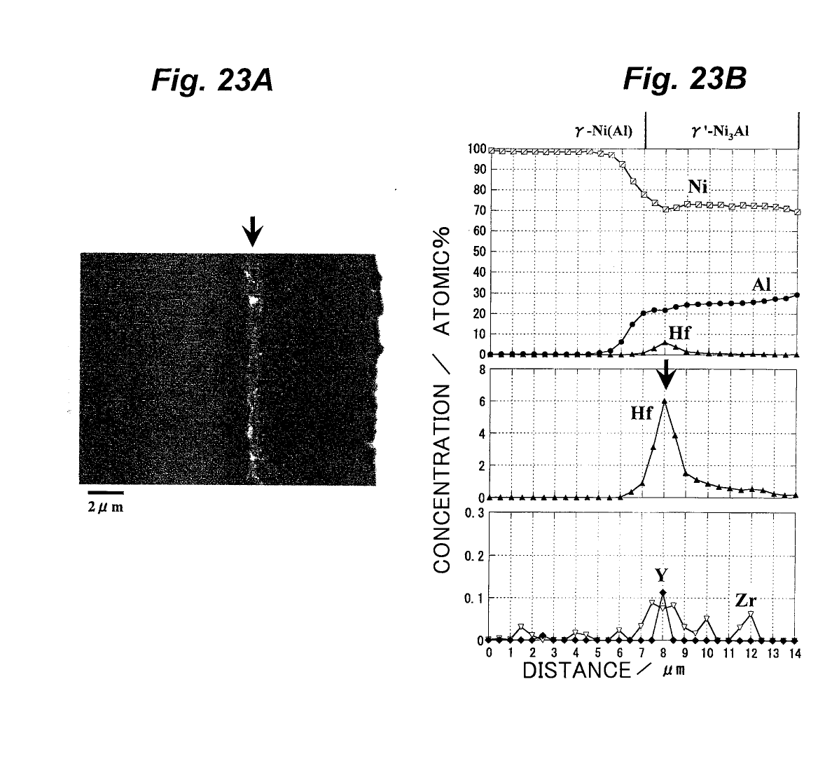

FIG. 23A is a cross-sectional photograph of an obtained sample in case that the Ni plate is heated at 800° C. for 9 hours using (Hf+Y) pack (5 weight % Hf+5 weight % Y), and FIG. 23B is the result of EPMA analysis.

As apparent from FIG. 23B, Al concentration is 30˜20 atomic %, and the main of the coating layer is γ′-Ni₃Al.

Hf concentration is 6 atomic % in inside of γ′-Ni₃Al (arrow).

Both 0.12 atomic % Y and 0.1 atomic % Zr are contained in the same place of the inside of γ′-Ni₃Al (arrow). Zr is contained in Hf powder as impurity of 2 weight %.

Y (single) pack is hard to add Y to the coating layer, but a combined pack of Hf+Y adds Y, which is a very important result.

### Example 17

Using an Ni plate as a metal substrate, and Ti+NH₄Cl+Al₂O₃ as a pack agent, heat treatment is carried out at 1000° C. for 1 hour in Ar atmosphere.

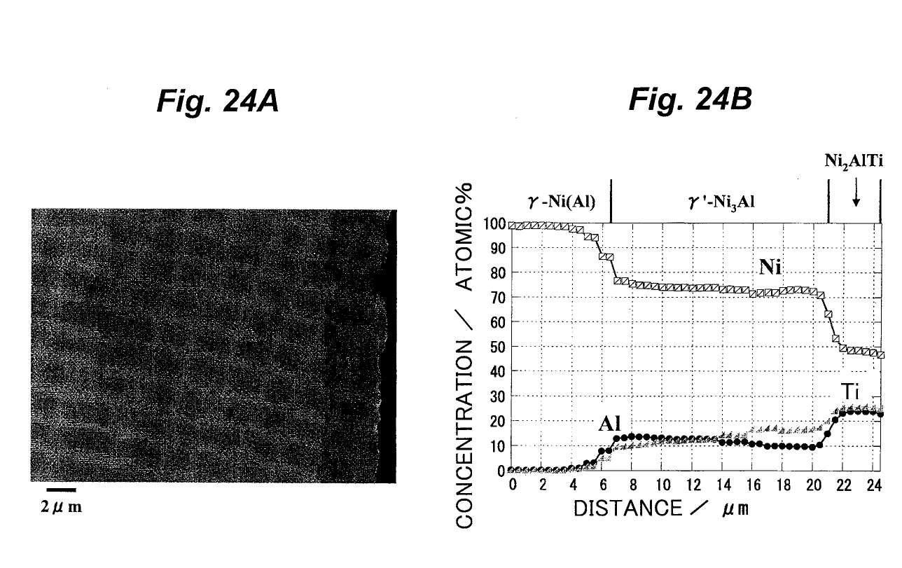

FIG. 24A shows a cross-sectional photograph of an obtained sample, and FIG. 24A shows the result of EPMA analysis.

As apparent from FIG. 24B, the coating layer is composed of γ′-Ni₃Al phase containing Ni₂AlTi and Ti and γ-Ni (Al) phase.

In this case, the following producing mechanism is proposed.

That is, HCl produced by a reaction of NH₄Cl═NH₃+HCl reacts with Ti, and produces TiCl₄ following the reaction formula of Ti+4HCl=TiCl₄+2H₂. TiCl₄ reacts with Al₂O₃, and produces TiO₂ and AlCl₃. That is, 3TiCl₄+2Al₂O₃=3TiO₂+4AlCl₃. These TiCl₄ and AlCl₃ move as gas bodies, precipitate Ti and Al on the surface of a metal substrate, and produce an aluminized layer containing Ti.

### Example 18

Using an Ni plate as a metal substrate and pack agents shown in Tables 2 and 3 using one element selected from Hf, Ti, Zr, Y as active metal, Cr₂O₃ or SiO₂ as oxide, and NH₄Cl as an activation agent, heat treatment is carried out at 1000° C. for 1 hour in Ar atmosphere.

The surfaces of obtained samples are measured by an element analyzer. The analyzing results of Ni, Al, Cr, Si, Hf, Zr, Y and Ti are shown in Tables 2 and 3.

TABLE 2

| | | Weight | | | | | | | |
|---|---|---|---|---|---|---|---|---|---|
| | | Change | Element Result (at. %) | | | | | | |
| | | mg/cm² | Ni | Al | Cr | Hf | Zr | Y | Ti |
| 1 | Hf: 5 wt. % | 1.77 | 77.62 | 0.27 | 21.78 | 0.23 | 0.11 | — | — |
| | NH₄Cl: 5 wt. % | | | | | | | | |
| | Al₂O₃: 45 wt. % | | | | | | | | |
| | Cr₂O₃: 45 wt. % | | | | | | | | |
| 2 | Ti: 5 wt. % | 2.21 | 61.43 | 2.07 | 36.12 | — | — | — | 0.24 |
| | NH₄Cl: 5 wt. % | | | | | | | | |
| | Al₂O₃: 45 wt. % | | | | | | | | |
| | Cr₂O₃: 45 wt. % | | | | | | | | |
| 3 | Zr: 5 wt. % | 1.77 | 68.56 | — | 31.35 | — | 0.09 | — | — |
| | NH₄Cl: 5 wt. % | | | | | | | | |
| | Cr₂O₃: 90 wt. % | | | | | | | | |
| 4 | Y: 5 wt. % | 1.77 | 82.34 | — | 17.40 | — | — | 0.25 | — |
| | NH₄Cl: 5 wt. % | | | | | | | | |
| | Cr₂O₃: 90 wt. % | | | | | | | | |

TABLE 3

| | | Weight | | | | | | | |
|---|---|---|---|---|---|---|---|---|---|
| | | Change | Element Result (at. %) | | | | | | |
| | | mg/cm² | Ni | Al | Cr | Hf | Zr | Y | Ti |
| 5 | Hf: 5 wt. % | 1.77 | 23.17 | — | — | 3.17 | 0.29 | — | — |
| | NH₄Cl: 5 wt. % | | | | | | | | |
| | SiO₂: 90 wt. % | | | | | | | | |
| 6 | Ti: 5 wt. % | 1.77 | 23.03 | — | — | — | — | — | 12.74 |
| | NH₄Cl: 5 wt. % | | | | | | | | |
| | SiO₂: 90 wt. % | | | | | | | | |
| 7 | Zr: 5 wt. % | 1.77 | 26.23 | — | — | — | 6.42 | — | — |
| | NH₄Cl: 5 wt. % | | | | | | | | |
| | SiO₂: 90 wt. % | | | | | | | | |
| 8 | Y: 5 wt. % | 1.77 | 26.47 | — | — | — | — | 8.41 | — |
| | NH₄Cl: 5 wt. % | | | | | | | | |
| | SiO₂: 90 wt. % | | | | | | | | |

As apparent from Table 2, in Hf (Cr₂O₃) pack, Cr concentration is 21.78 atomic %, and Hf concentration is 0.23 atomic %. In Ti (Cr₂O₃) pack, Cr concentration is 36.12 atomic %, and Ti concentration is 0.24 atomic %. In Zr (Cr₂O₃) pack, Cr concentration is 31.35 atomic %, and Zr concentration is 0.09 atomic %. In Y (Cr₂O₃) pack, Cr concentration is 17.40 atomic %, and Y concentration is 0.25 atomic %.

In this case, the following producing mechanism is proposed. That is, HCl produced by the reaction of NH₄Cl═NH₃+HCl reacts with active metal (M=Hf, Ti, Ar), then produces MCl₄ following the reaction formula M+4HCl=MCl₄+2H₂. The MCl₄ reacts with Cr₂O₃, then produces MO₂ and CrCl₃. That is, 3MCl₄+2Cr₂O₃=3MO₂+4CrCl₃. These MCl₄ and CrCl₃ move as gas bodies, precipitate M and Cr on the surface of the metal substrate, and produce a chromized layer containing M. In case that active metal is Y, the above producing mechanism can be applied, except that Y produces Y₂O₃ and YCl₃.

As apparent from Table 3, in Hf (SiO₂) pack, Si concentration is 73.37 atomic %, and Hf concentration is 3.17 atomic %. In Ti (SiO₂) pack, Si concentration is 64.23 atomic %, and Ti concentration is 12.74 atomic %. In Zr (SiO₂) pack, Si concentration is 67.35 atomic %, and Zr concentration is 6.42 atomic %. In Y (SiO₂) pack, Si concentration is 65.13 atomic %, and Y concentration is 8.41 atomic %.

In this case, the following producing mechanism is proposed. That is, HCl produced by the reaction of NH₄Cl═NH₃+HCl reacts with active metal (M=Hf, Ti, Zr), then produces MCl₄ following a reaction formula M+4HCl=MCl₄+2H₂. The MCl₄ reacts with SiO₂, then produces MO₂ and SiCl₄. That is, MCl₄+SiO₂=MO₂+SiCl₄, These MCl₄ and SiCl₄ move as gas bodies, precipitate M and Al on the surface of the metal substrate, and produce a siliconized layer containing M. In case that active metal is Y, the above producing mechanism can be applied, except that Y produces Y₂O₃ and YCl₃.

### Example 19

Using a CMSX-4 plate as a metal substrate, and Hf as active metal, heat treatment is carried out at a temperature of 1000° C. for 1 hour in Ar atmosphere.

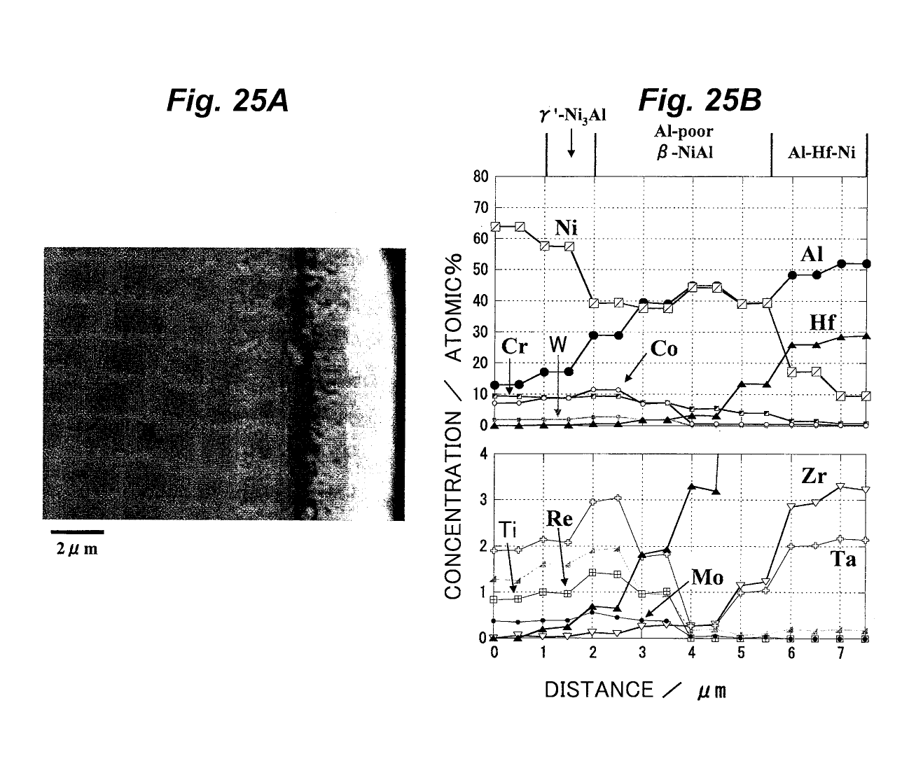

FIG. 25A shows a cross-sectional photograph of an obtained sample, and FIG. 25B shows the result of EPMA analysis.

As apparent from FIG. 25B, Al concentration is about 52 atomic % on the surface, 30 atomic % in about 5 μm depth, then, after decreasing to 18 atomic %, gradually decreases towards the inside.

Hf concentration is about 29 atomic % on the surface, after decreasing to 13 atomic % in about 2 μm depth, gradually decreases.

Zr concentration is 3.3 atomic % on the surface, and shows similar distribution to Hf concentration towards the inside. Detected Zr is contained in Hf powder as impurity, which is 2 weight %.

Regarding the coating layer, unclear points still remain due to a multiple system and complexity. However, it is considered that the coating layer is composed of Al—Hf—Ni compound, Al poor β-NiAl phase, γ′-Ni₃Al phase, and a mixed phase of these three.

### Example 20

Using a CMSX-4 plate on which 30 μm thick Ni is plated as a metal substrate, and Hf as active metal, heat treatment is carried out at a temperature of 1000° C. for 1 hour in Ar atmosphere.

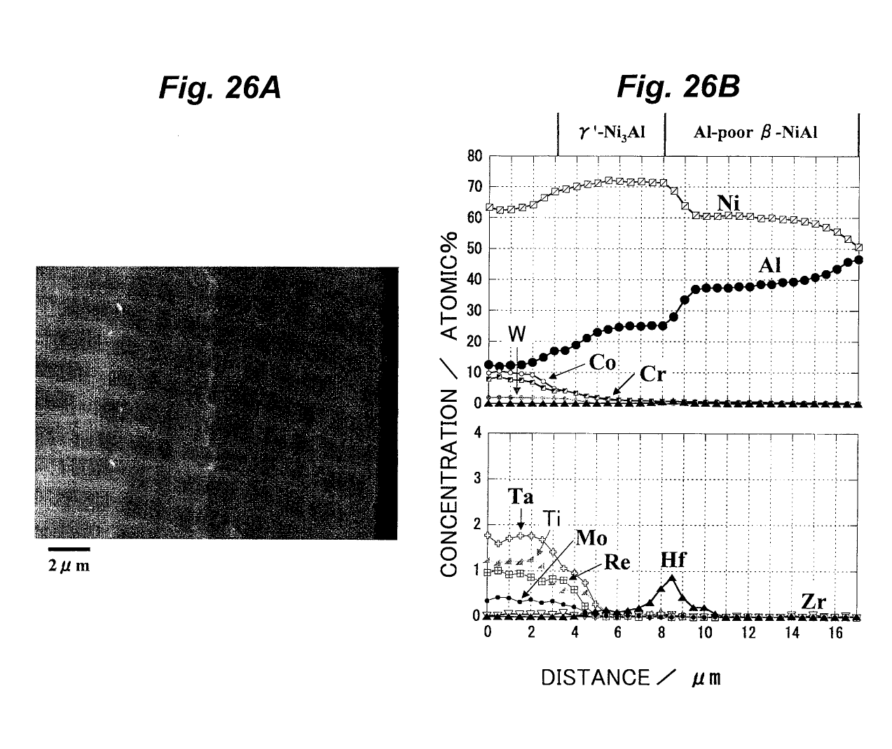

FIG. 26A shows a cross-sectional photograph of an obtained sample, and FIG. 26B shows the result of EPMA analysis.

As apparent from FIG. 26B, Al concentration is 46 atomic % on the surface, 24 atomic % in about 8 μm depth, then, after decreasing to 18 atomic %, 35 atomic % in 12 μm depth, then, after decreasing to 25 atomic %, gradually decreases towards the inside.

The layers of the sample are, from the surface, Al poor β-NiAl phase, and γ′-Ni₃Al phase.

Hf concentration is detection limit in Al poor β-NiAl phase, however, about 0.9 atomic % exists in γ′-Ni₃Al phase(arrow). The fact that Hf exists inside of the coating layer is a very important result.

### Example 21

Using a TMS-82+ plate as a metal substrate, and Hf as active metal, heat treatment is carried out at a temperature of 1000° C. for 1 hour in Ar atmosphere.

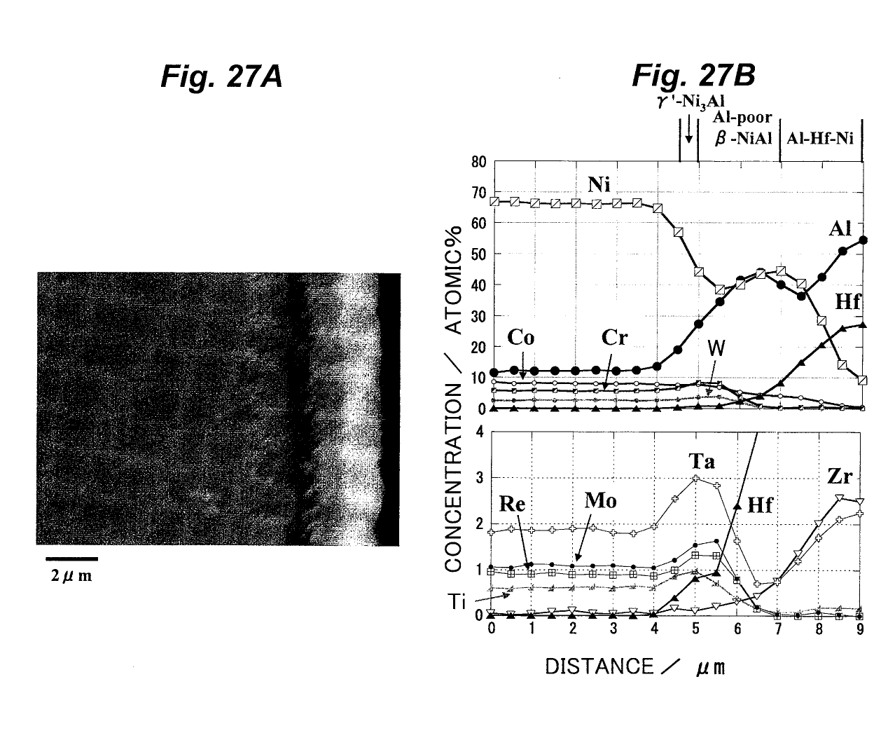

FIG. 27A shows a cross-sectional photograph of an obtained sample, and FIG. 27B shows the result of EPMA analysis.

As apparent from FIG. 27B, Al concentration is about 54 atomic % on the surface, then, after decreasing to 35 atomic % in about 3.5 μm depth, gradually decreases towards the inside. The whole depth is 5 μm.

Hf concentration is about 28 atomic % on the surface, 2.5 atomic % in about 3 μm depth, and is detection limit in 5 μm depth.

Zr concentration is 2.5 atomic % on the surface, and shows similar distribution to Hf concentration towards the inside. The detected Zr is contained in Hf powder as impurity, which is 2 weight %.

Regarding the coating layer, unclear points still remain due to a multiple system and complexity. However, it is considered that the coating layer is composed of Al—Hf—Ni compound, Al poor β-NiAl phase, and a mixed phase of these two.

### Example 22

Using a TMS-82+plate on which 30 μm thick Ni is plated as a metal substrate, and Hf as active metal, heat treatment is carried out at a temperature of 1000° C. for 1 hour in Ar atmosphere.

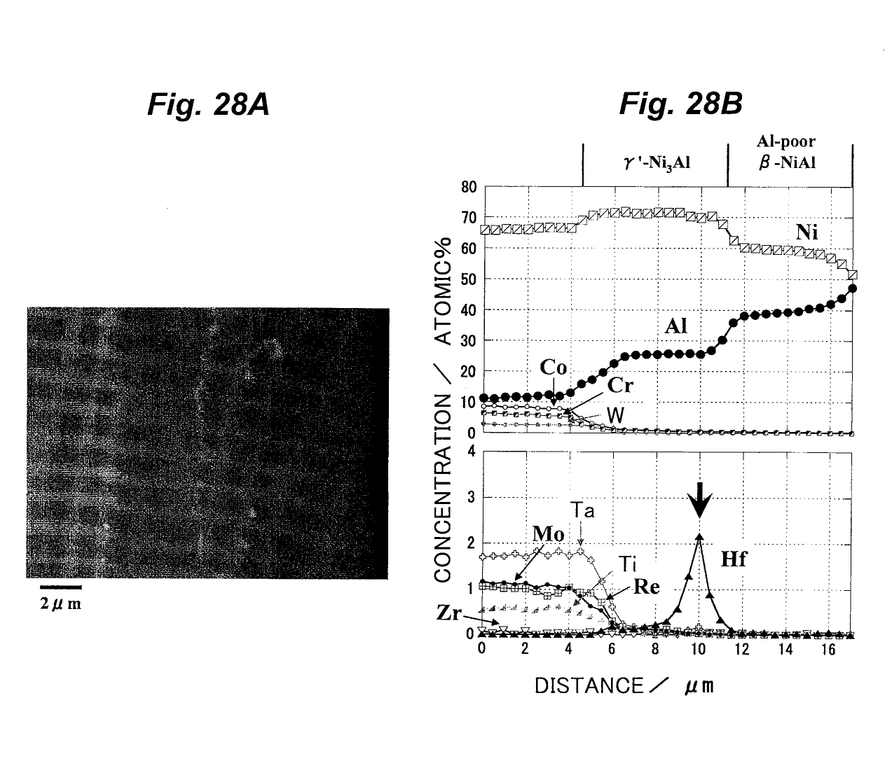

FIG. 28A shows a cross-sectional photograph of an obtained sample, and FIG. 28B shows the result of EPMA analysis.

As apparent from FIG. 28B, Al concentration is 48 atomic % on the surface, 35 atomic % in about 6 μm depth, then, decreases to 27 atomic %, and is 20 atomic % in 11 μm depth, after that, Al concentration sharply decreases. The thickness of the coating layer is about 13 μm.

The layers of the sample are, from the surface, Al poor β-NiAl phase, and γ′-Ni₃Al phase. Hf concentration is detection limit in Al poor β-NiAl phase, however, 2.2 atomic % Hf exists in γ′-Ni₃Al phase (arrow). The fact that Hf exists inside of this coating layer is a very important result.

### Example 23

Using a Rene' 80 plate as a metal substrate, and Hf as active metal, heat treatment is carried out at a temperature of 1000° C. for 1 hour in Ar atmosphere.

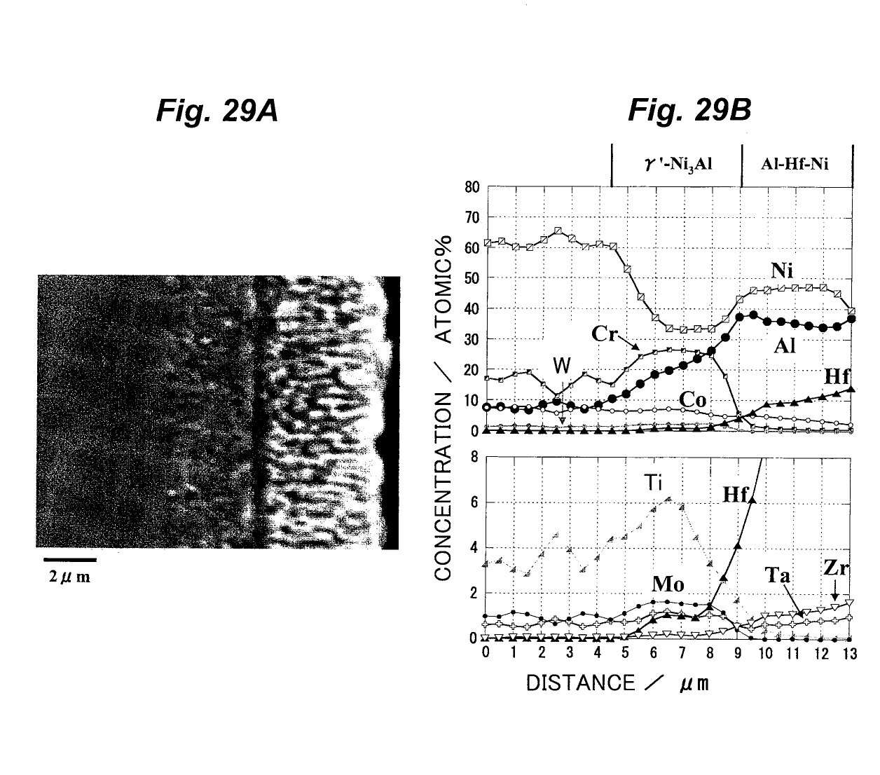

FIG. 29A shows a cross-sectional photograph of an obtained sample, and FIG. 29B shows the result of EPMA analysis.

As apparent from FIG. 29B, Al concentration is about 37 atomic % on the surface, 30 atomic in about 4.5 μm depth, after that, gradually decreases towards the inside. The whole depth is about 9 μm.

Hf concentration is about 14 atomic % on the surface, 9 atomic % in about 3 μm depth, then decreases to about 1 atomic %, and further decreases to detection limit.

Zr concentration is 1.7 atomic % on the surface, and shows similar distribution to Hf concentration towards the inside. The detected Zr is contained in Hf powder as impurity, which is 2 weight %.

Regarding the coating layer, unclear points still remain due to a multiple system and complexity. However, it is considered that the coating layer is composed of Al poor β-NiAl phase containing Hf, γ′-Ni₃Al phase and a mixed phase of these two.

### Example 24

Using a Rene' 80 plate on which 30 μm thick Ni is plated as a metal substrate, and Hf as active metal, heat treatment is carried out at a temperature of 1000° C. for 1 hour in Ar atmosphere.

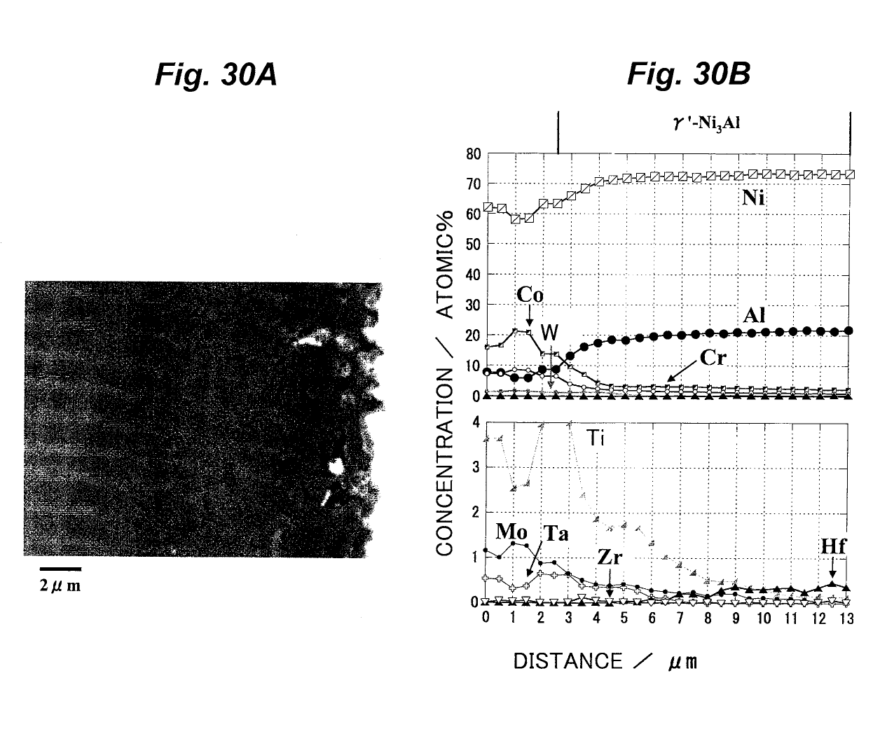

FIG. 30A shows a cross-sectional photograph of an obtained sample, and FIG. 30B shows the result of EPMA analysis.

As apparent from FIG. 30B, Al concentration is 21 atomic % on the surface, decreases to 18 atomic % in about 9 μm depth, then, sharply reduces. The thickness of the coating layer is about 11 μm.

The Layer of the sample is γ′-Ni₃Al phase from the surface.

Hf concentration is 0.2˜0.3 atomic % from the surface to 6 μm depth, after that, is detection limit.

### Example 25

Using a Hastelloy-X plate as a metal substrate, and Hf as active metal, heat treatment is carried out at a temperature of 1000° C. for 1 hour in Ar atmosphere.

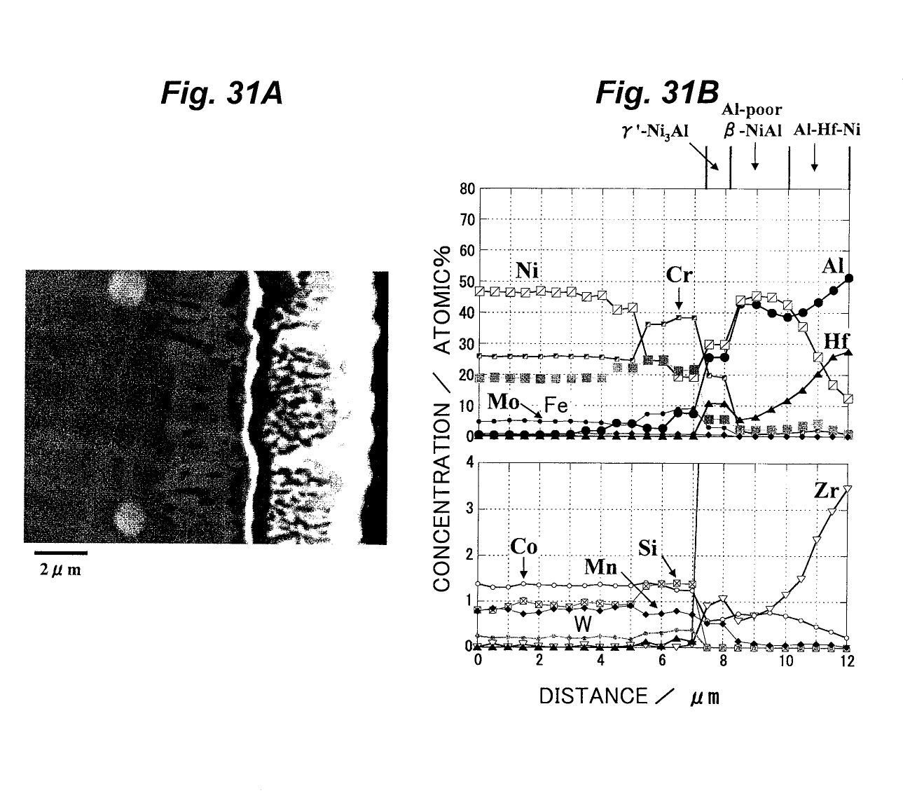

FIG. 31A shows a cross-sectional photograph of an obtained sample, and FIG. 31B shows the result of EPMA analysis.

As apparent from FIG. 31B, Al concentration is about 50 atomic % on the surface, 40 atomic % in about 4 μm depth, then, decreases to 25 atomic %, and is 8 atomic % in 5 μm depth, after that, gradually decreases towards the inside. The whole depth is 8 μm.

Hf concentration is about 28 atomic % on the surface, 5 atomic % in about 4 μm depth, then, increases to 10 atomic %, after that sharply decreases in 5 μm depth.

Zr concentration is 3.5 atomic % on the surface, and shows similar distribution to Hf concentration. The detected Zr is contained in Hf powder as impurity, which is 2 weight %.

Regarding the coating layer, unclear points still remain due to a multiple system and complexity. However, it is considered that the coating layer is composed of Al—Hf—Ni compound, Al poor β-NiAl phase, γ′-Ni₃Al phase and a mixed phase of these three.

It is a very important result that the high Hf concentration aluminized layer is produced.

### Example 26

Using a Hastelloy-X plate on which 30 μm thick Ni is plated as a metal substrate, and Hf as active metal, heat treatment is carried out at a temperature of 1000° C. for 1 hour in Ar atmosphere.

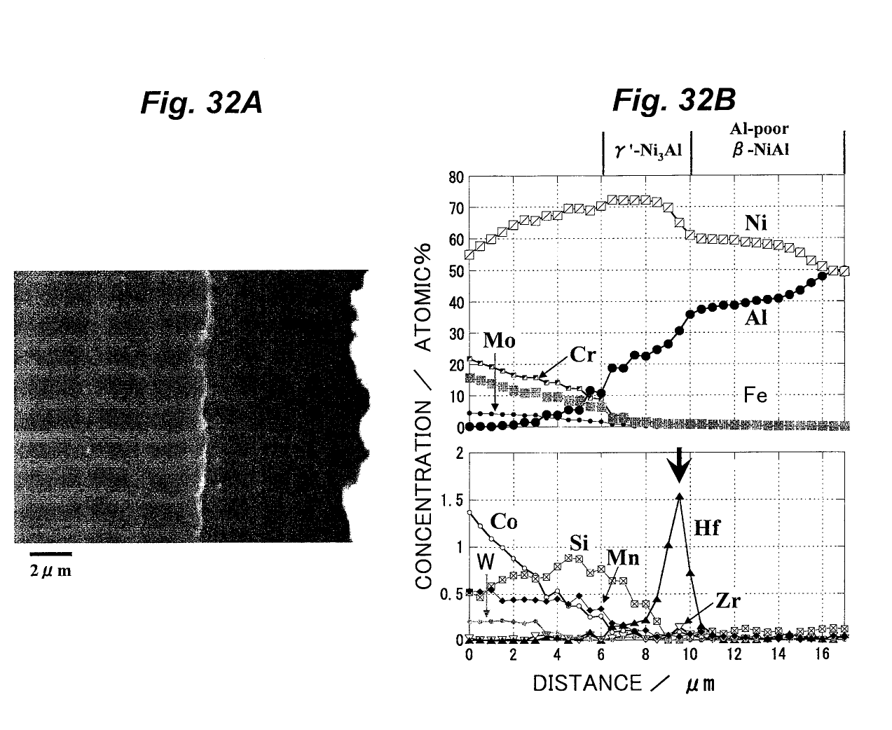

FIG. 32A shows a cross-sectional photograph of an obtained sample, and FIG. 32B shows the result of EPMA analysis.

As apparent from FIG. 32B, Al concentration is 50 atomic % on the surface, 38 atomic % in about 9 μm depth, then, decreases to 27 atomic %, and is 10 atomic % in 11 μm depth, after that, gradually decreases towards the inside.

The layers of the sample are, from the surface, Al poor β-NiAl phase and γ′-Ni₃Al phase. Hf concentration is detection limit in Al poor β-NiAl phase, however, about 1.6 atomic % Hf exists in γ′-Ni₃Al phase (arrow). The fact is a very important result.

### Example 27

Using a Hastelloy-C plate as a metal substrate, and Hf as active metal, heat treatment is carried out at a temperature of 1000° C. for 1 hour in Ar atmosphere.

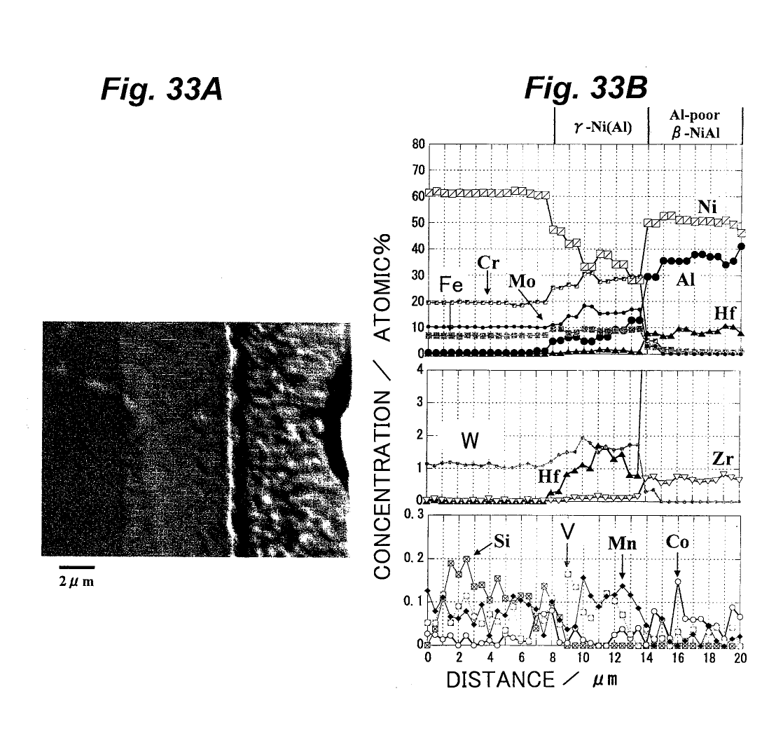

FIG. 33A shows a cross-sectional photograph of an obtained sample, and FIG. 33B shows the result of EPMA analysis.

As apparent from FIG. 33B, Al concentration is about 40 atomic % on the surface, 30 atomic % in about 6 μm depth, then, decreases to 13 atomic %, after that gradually decreases towards the inside. The whole depth is 13 μm.

Hf concentration is about 10 atomic % on the surface, 8 atomic % in about 6 μm depth, then increases to 0.8˜1.8 atomic %, after that sharply decreases in 13 μm depth.

Zr concentration is 0.8 atomic % on the surface, and shows similar distribution to Hf concentration towards the inside. The detected Zr is contained in Hf powder as impurity, which is 2 weight %.

Regarding the coating layer, unclear points still remain due to a multiple system and complexity. However, it is considered that the coating layer is composed of Al poor β-NiAl phase containing Hf, γ-Ni (Al) phase and a mixed phase of these two.

It is a very important result that the high Hf concentration aluminized layer is produced.

### Example 28

Using a Hastelloy-C plate on which 30 μm thick Ni is plated as a metal substrate, and Hf as active metal, heat treatment is carried out at a temperature of 1000° C. for 1 hour in Ar atmosphere.

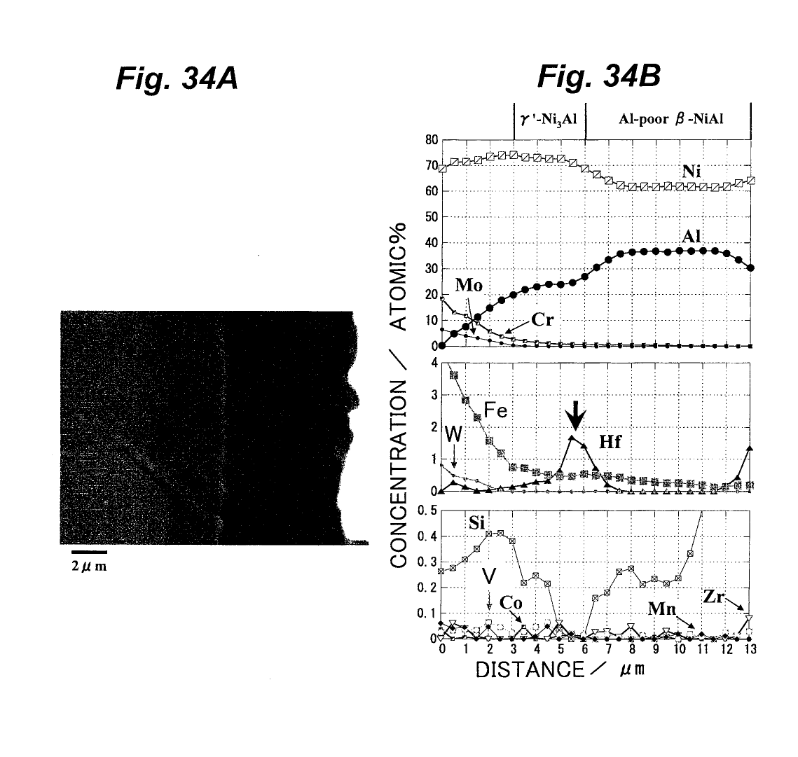

FIG. 34A shows a cross-sectional photograph of an obtained sample, and FIG. 34B shows the result of EPMA analysis.

As apparent from FIG. 34B, Al concentration is 30˜37 atomic % on the surface, 24 atomic % in about 7 μm depth, there, decreases to 18 atomic %, and is 10 atomic % in 12 μm depth, after that, gradually decreases towards the inside. The thickness of the coating layer is about 13 μm.

The layers of the sample are, from the surface, Al poor β-NiAl phase, γ′-Ni₃Al phase, and γ-Ni (Al) phase.

Hf concentration is 1.3 atomic % in Al poor β-NiAl phase, and immediately decreases to under detection limit, however, about 1.7 atomic % exists in γ′-Ni₃Al phase (arrow). The fact is a very important result.

### Example 29

Using an INCONEL-625 plate as a metal substrate, and Hf as active metal, heat treatment is carried out at a temperature of 1000° C. for 1 hour in Ar atmosphere.

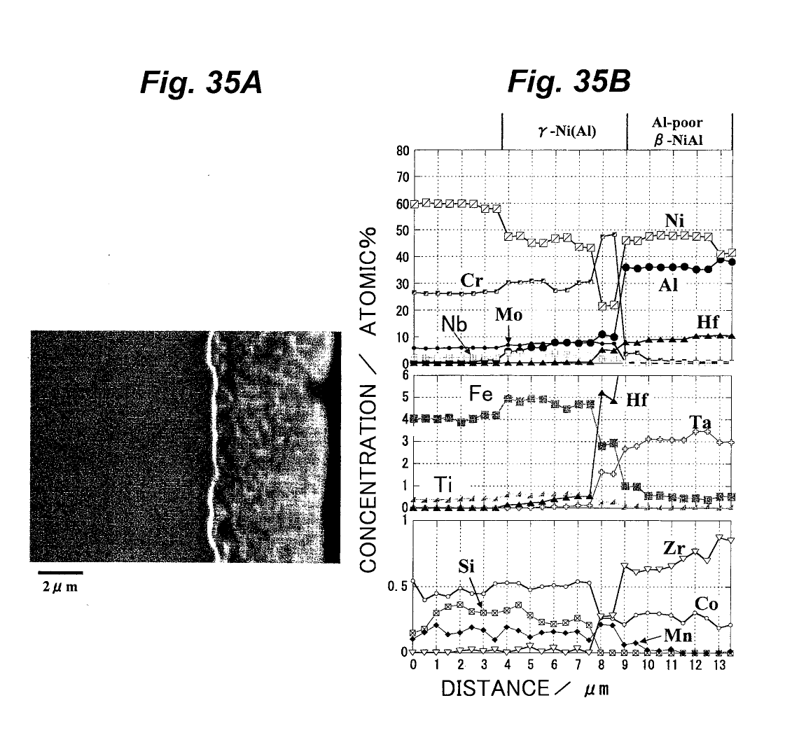

FIG. 35A shows a cross-sectional photograph of an obtained sample, and FIG. 35B shows the result of EPMA analysis.

As apparent from FIG. 35B, Al concentration is about 38˜35 atomic % on the surface, decreases to 10 atomic % in about 4.5 μm depth, then gradually decreases towards the inside. The whole depth is 10 μm.

Hf concentration is about 10 atomic % on the surface, 8 atomic % in about 4.5 μm depth, there, 0.6 atomic %, then decreases to under detection limit in 10 μm depth.

Zr concentration is 0.8 atomic % on the surface, and shows similar distribution to Hf concentration towards the inside. The detected Zr is contained in Hf powder as impurity, which is 2 weight %.

Regarding the coating layer, unclear points still remain due to a multiple system and complexity. However, it is considered that the coating layer is composed of Al poor β-NiAl phase containing Hf, γ-Ni (Al) phase, and a mixed phase of these two.

It is a very important result that the high Hf concentration aluminized layer is produced.

### Example 30

Using an INCONEL-625 plate on which 30 μm thick Ni is plated as a metal substrate, and Hf as active metal, heat treatment is carried out at 1000° C. for 1 hour in Ar atmosphere.

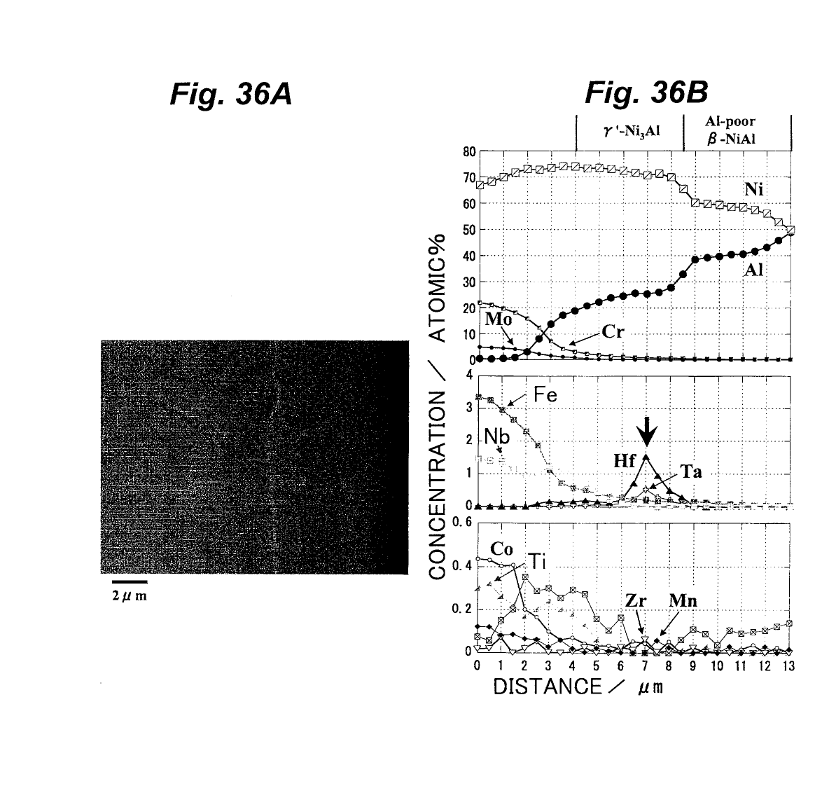

FIG. 36A shows a cross-sectional photograph of an obtained sample, and FIG. 36B shows the result of EPMA analysis.

As apparent from FIG. 36B, Al concentration is 50 atomic % on the surface, 39 atomic % in about 4 μm depth, there decreases to 28 atomic %, then 10 atomic % in 11 μm depth, then sharply decreases. The thickness of the coating layer is about 11 μm.

The layers of the sample are, from the surface, Al poor β-NiAl phase, γ′-Ni₃Al phase, and γ-Ni (Al) phase.

Hf concentration is under detection limit in Al poor β-NiAl phase, however, about 1.5 atomic % exists in γ′-Ni₃Al phase(arrow).

The fact is a very important result.

### Example 31

Using a SUS304 plate as a metal substrate, and Hf as active metal, heat treatment is carried out at a temperature of 1000° C. for 1 hour in Ar atmosphere.

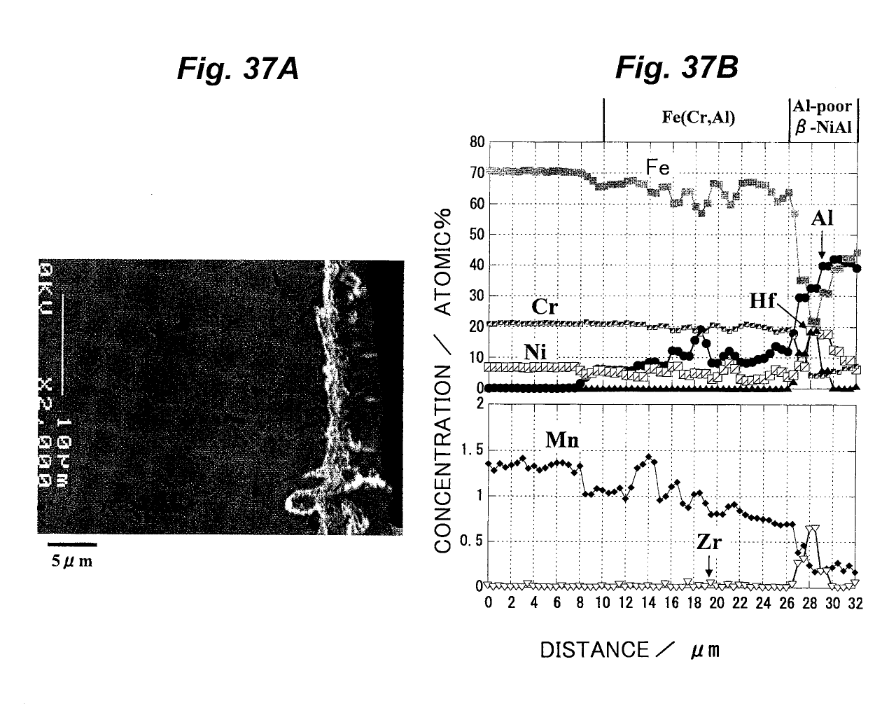

FIG. 37A shows a cross-sectional photograph of an obtained sample, and FIG. 37B shows the result of EPMA analysis.

As apparent from FIG. 37B, Al concentration is about 47 atomic % on the surface, decreases 32 atomic % in about 8 μm depth, after that, sharply decreases to 8 atomic %, and gradually decreases towards the inside. The whole depth is 15 p.m.

Hf concentration is 8˜16 atomic % on the surface, decreases from 0.6 atomic % in about 4 μm depth to 0.2 atomic %, and increases to 2.3 atomic %, then decreases to detection limit.

Zr concentration is 1.2 atomic % on the surface, and shows similar distribution to Hf concentration towards the inside. The detected Zr is contained in Hf powder as impurity, which is 2 weight %.

Regarding the coating layer, unclear points still remain due to a multiple system and complexity. However, it is considered that the coating layer is composed of Al poor β-NiAl phase containing Hf, Fe (Cr, Al) phase, and a mixed phase of these two.

It is a very important result that the high Hf concentration aluminized layer is produced.

### Example 32

Using a SUS304 plate on which 30 μm thick Ni is plated as a metal substrate, and Hf as active metal, heat treatment is carried out at a temperature of 1000° C. for 1 hour in Ar atmosphere.

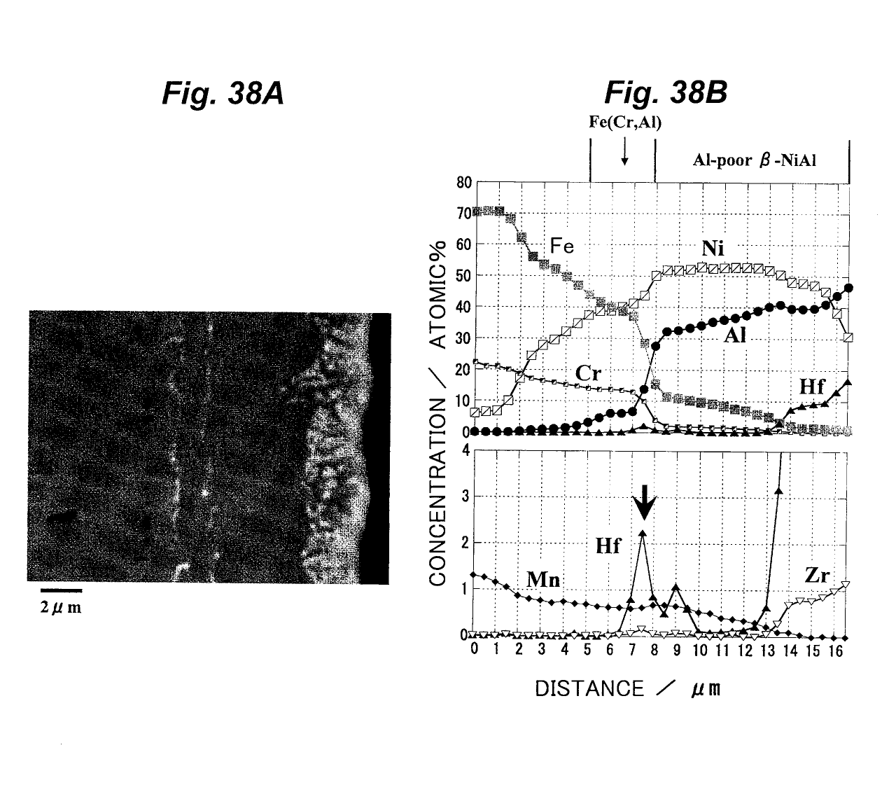

FIG. 38A shows a cross-sectional photograph of an obtained sample, and FIG. 38B shows the result of EPMA analysis.

As apparent from FIG. 38B, Al concentration is 40 atomic % on the surface, decreases to 12 atomic % in about 6 μm depth, and 7 atomic % in 22 μm depth, then sharply decreases. The thickness of the coating layer is about 24 μm.

The layers of the sample are, from the surface, Al poor β-NiAl phase, and Fe (Cr, Al) phase. Hf concentration is 16˜8 atomic % Hf on the surface of Al poor β-NiAl phase, however, it is under detection limit in under 4 μm depth. Hf concentration is the highest 2.2 atomic % between Al poor β-NiAl phase, and Fe (Cr, Al) phase (arrow), and is detection limit in Fe (Cr, Al) phase.

It is a very important result that the high Hf concentration is produced in an aluminized layer.

### Example 33

Using an Ni plate as a metal substrate, a pack agent shown in Tables 4 and 5 contain one of Mg, Ca, Ti, Y, Zr and Hf as active metal, Al₂O₃ as metal oxide, and NaCl as catalytic compound, heat treatment is carried out at a temperature of 1200° for 2 hours in vacuum atmosphere.

The results of analysis of Ni, Al, Mg, Ca, Ti, Y, Zr and Hf, measuring the surface of the obtained sample by an element analyzer, are shown in Tables 4 and 5.

TABLE 4

| | | Weight | | | |
|---|---|---|---|---|---|
| | Composition | Change | Element Result (at. %) | | |
| | of Pack Agent | mg/cm² | Ni | Al | Mg, Ca, Ti, Y, Zr, Hf |
| 1 | Mg: 9 wt. % | 46.22 | 36.94 | 49.00 | Mg: 14.04 |
| | Ni: 1 wt. % | | | | |
| | NaCl: 1 wt. % | | | | |
| | Al₂O₃: 89 wt. % | | | | |
| 2 | Ca: 9 wt. % | 20.33 | 39.40 | 57.42 | Ca: 3.17 |
| | Ni: 1 wt. % | | | | |
| | NaCl: 1 wt. % | | | | |
| | Al₂O₃: 89 wt. % | | | | |
| 3 | Ti: 9 wt. % | 10.08 | 45.63 | 53.20 | Ti: 1.16 |
| | Ni: 1 wt. % | | | | |
| | NaCl: 1 wt. % | | | | |
| | Al₂O₃: 89 wt. % | | | | |

TABLE 5

| | | Weight | | | |
|---|---|---|---|---|---|
| | Composition | Change | Element Result (at. %) | | |
| | of Pack Agent | mg/cm² | Ni | Al | Mg, Ca, Ti, Y, Zr, Hf |
| 4 | Y: 9 wt. % | 36.38 | 42.03 | 57.57 | Y: 0.39 |
| | Ni: 1 wt. % | | | | |
| | NaCl: 1 wt. % | | | | |
| | Al₂O₃: 89 wt. % | | | | |
| 5 | Zr: 9 wt. % | 30.07 | 55.08 | 43.91 | Zr: 0.99 |
| | Ni: 1 wt. % | | | | |
| | NaCl: 1 wt. % | | | | |
| | Al₂O₃: 89 wt. % | | | | |
| 6 | Hf: 9 wt. % | 18.04 | 52.42 | 47.13 | Hf: 0.43 |
| | Ni: 1 wt. % | | | | |
| | NaCl: 1 wt. % | | | | |
| | Al₂O₃: 89 wt. % | | | | |

As apparent from Table 4, in Mg pack, Al concentration is 49.00 atomic %, and Mg concentration is 14.04 atomic %. In this case, the following producing mechanism is proposed. That is, NaCl dissolves at a temperature of 803° C., and a part of NaCl moves as a gas body at a temperature of 1200° C., reacts with active metal Mg, and produces MgCl₂ following a reaction formula 2NaCl+Mg=2Na+MgCl₂. The MgCl₂ reacts with Al₂O₃, then produces 3MgCl₂+Al₂O₃=3MgO+2AlCl₃. These MgCl₂ and AlCl₃ move as gas bodies, precipitate Mg and Al on the surface of the Ni metal, and produces an aluminized layer containing Mg.

In Ca pack, Al concentration is 57.42 atomic %, and Ca concentration is 3.17 atomic %. In case that active metal is Ca, the above producing mechanism can be applied, except that Ca produces CaO and CaCl₂.

In Ti pack, Al concentration is 53.20 atomic %, and Ti concentration is 1.16 atomic %. In this case, the following producing mechanism is proposed. That is, NaCl dissolves at a temperature of 803° C. and a part of NaCl moves as a gas body at a temperature of 1200° C., and reacts with an active metal Ti, and produces TiCl₄ following a reaction formula 4NaCl+TiNa+TiCl₄. The TiCl₄ reacts with Al₂O₃, then produces 3TiCl₄+2Al₂O₃=3TiO₂+4AlCl₃. These TiCl₄ and AlCl₃ move as gas bodies, precipitate Ti and Al on the surface of the Ni metal, and produces an aluminized layer containing Ti.

As apparent from Table 5, in Y pack, Al concentration is 57.57 atomic %, and Y concentration is 0.39 atomic %. In this case, the following producing mechanism is proposed. That is, NaCl dissolves at a temperature of 803° C., and a part of NaCl moves as a gas body at a temperature of 1200° C., reacts with active metal Y, and produces YCl₃ following a reaction formula 3NaCl+Y=3Na+YCl₃. The YCl₃ reacts with Al₂O₃, then produces 2YCl₃+Al₂O₃—Y₂O₃+2AlCl₃. These YCl₃ and AlCl₃ move as gas bodies, precipitate Y and Al on the surface of the Ni metal, and produces an aluminized layer containing Y.

In Zr pack, Al concentration is 43.91 atomic %, and Zr concentration is 0.99 atomic %. In case that active metal is Zr, the above producing mechanism can be applied, except that Zr produces ZiO₂ and ZrCl₄.

In Hf pack, Al concentration is 47.13 atomic %, and Hf concentration is 0.43 atomic %. In case that active metal is Hf, the above producing mechanism can be applied, except that Hf produces HfO₂ and HfCl₄.

### Example 34

Using an Ni plate as a metal substrate, a pack agent shown in Table 6 containing Hf as active metal, Al₂O₃ as metal oxide, and NaCl as catalytic compound, heat treatment is carried out at a temperature of 1300° C. for 2 hours in vacuum atmosphere.

The results of analysis of Ni, Al, and Hf, measuring the surface of the obtained sample by an element analyzer, are shown in Table 6.

TABLE 6

| | Weight | | | |
|---|---|---|---|---|
| Composition | Change | Element Result (at. %) | | |
| of Pack Agent | mg/cm² | Ni | Al | Hf |
| Hf: 9 wt. % | 22.23 | 32.12 | 65.42 | 0.99 |
| Ni: 1 wt. % | | | | |
| NaCl: 1 wt. % | | | | |
| Al₂O₃: 89 wt. % | | | | |

As apparent from Table 6, in Hf pack, Al concentration is 65.42 atomic %, and Hf concentration is 0.99 atomic %. In this case, the following producing mechanism is proposed. That is, NaCl dissolves at a temperature of 803° C., and a part of NaCl moves as a gas body at a temperature of 1300° C., reacts with active metal Hf, and produces MgCl₄ following a reaction formula 4NaCl+Hf=4Na+HfCl₄. The HfCl₄ reacts with Al₂O₃, then produces 3HfCl₄+2Al₂O₃=3HfO₂+4AlCl₃. These HfCl₄ and AlCl₃ move as gas bodies, precipitate Hf and Al on the surface of the Ni metal, and produces an aluminized layer containing Hf Heretofore, embodiments and examples of the present invention have been explained specifically. However, the present invention is not limited to these embodiments and examples, but contemplates various changes and modifications based on the technical idea of the present invention.

For example, ReO₂ can be used as metal oxide to be contained in diffusion and penetration processing agent, and in this case Al, Cr, and Hf or the like are used as active metal.

For example, in case of using ReO₂ as metal oxide, Al as active metal, and HCl as catalytic compound, the reactions corresponding to the above formulas (2) and (3) are as follows, and it is possible to make Al and Re diffuse and penetrate simultaneously.

2Al+6HCl=2AlCl₃+3H₂

3ReO₂+4AlCl₃=2Al₂O₃+3ReCl₄

Also, in case of using ReO₂ as metal oxide, Cr as active metal, and HCl as catalytic compound, the reactions corresponding to the above formulas (2) and (3) are as follows, and it is possible to make Cr and Re diffuse and penetrate simultaneously.

1. A method of producing an oxidation resistant alloy coating film on the surface of a metal substrate,
wherein said oxidation resistant alloy coating film is produced by embedding said metal substrate in a diffusion and penetration processing agent containing metal oxide, active metal and catalytic compound and carrying out heat treatment, so that said oxidation resistant alloy coating film contains the metal constituting said metal oxide and said active metal.

2. The method of producing an oxidation resistant alloy coating film according to claim 1 wherein said metal oxide contains oxide containing at least one kind of metal selected from the group consisting of Al, Cr and Si.

3. The method of producing an oxidation resistant alloy coating film according to claim 1 wherein said metal oxide contains oxide containing at least one kind of oxide selected from the group consisting of Al₂O₃, Cr₂O3 and SiO2.

4. The method of producing an oxidation resistant alloy coating film according to claim 1 wherein said active metal contains at least one kind of metal selected from the group consisting of Hf, Zr, Y, Ti, La, Ce, Mg and Ca.

5. The method of producing an oxidation resistant alloy coating film according to claim 4 wherein said active metal further contains at least one kind of metal constituting said metal oxide.

6. The method of producing an oxidation resistant alloy coating film according to claim 1 wherein said catalytic compound is a halogen compound and the change of Gibbs's generation free energy is negative thermodynamically in a reaction in which oxide of said active metal and halogen compound of the metal constituting said metal oxide are produced by a reaction of a halogen compound of said active metal and said metal oxide.

7. The method of producing an oxidation resistant alloy coating film according to claim 1 wherein said catalytic compound contains at least one kind of compound selected from the group consisting of NH4Cl, NH4F, HCl, NaCl and NaF.

8. The method of producing an oxidation resistant alloy coating film according to claim 1 wherein said heat treatment is carried out at a temperature higher than the thermal decomposition temperature or sublimation temperature and lower than the melting point of said metal substrate.

9. The method of producing an oxidation resistant alloy coating film according to claim 1 wherein said heat treatment is carried out at a temperature of 700˜1340° C. for 1 minute˜25 hours in an atmosphere of inert gas or hydrogen gas.

10. The method of producing an oxidation resistant alloy coating film according to claim 1 wherein said diffusion and penetration processing agent contains at least one kind of metal selected from the group consisting of Hf, Zr, Y, Ti and Mg by less than 89 weight % and NH4Cl by 1˜10 weight % and the rest is Al2O3.

11. The method of producing an oxidation resistant alloy coating film according to claim 1 wherein said oxidation resistant alloy coating film comprises at least one phase selected from the group consisting of γ-Ni phase, γ′-Ni₃Al phase, β-NiAl phase and δ-Ni2Al3 phase, said γ-Ni phase contains 0.005 atomic %<(Hf+Zr+Y+Ti+Mg)<1 atomic % and 5 atomic %<Al<15 atomic %, said γ′-Ni3Al phase contains 0.005 atomic %<(Hf+Zr+Y+Ti+Mg)<10 atomic % and 16 atomic %<Al<27 atomic %, said β-NiAl phase contains 0.005 atomic %<(Hf+Zr+Y+Ti+Mg)<30 atomic % and 30 atomic %<Al<58 atomic %, and said δ-Ni2Al3 phase contains 0.005 atomic %<(Hf+Zr+Y+Ti+Mg)<3 atomic % and 59 atomic %<Al<62 atomic %.

12. The method of producing an oxidation resistant alloy coating film according to claim 11 wherein said γ-Ni phase further contains 0.1˜45 atomic % Cr, said γ′-Ni₃Al phase further contains 0.1˜7 atomic % Cr, said β-NiAl phase further contains 0.1˜10 atomic % Cr and said δ-Ni₂Al3 phase further contains 0.1˜5 atomic % Cr.

13. The method of producing an oxidation resistant alloy coating film according to claim 1 wherein said γ-Ni phase, said γ′-Ni3Al phase, said β-NiAl phase and said δ-Ni2Al3 phase further contain at least one element selected from the group consisting of V, Nb, W, Mo, Ta, Pt, Ir, Ru, Co, Fe, Mn and Si by transport from said metal substrate and environment by 0.01˜15 atomic %.

14. An oxidation resistant alloy coating film produced on the surface of a metal substrate,
wherein said oxidation resistant alloy coating film is produced by embedding said metal substrate in a diffusion and penetration processing agent containing metal oxide, active metal and catalytic compound and carrying out heat treatment, so that said oxidation resistant alloy coating film contains the metal constituting said metal oxide and said active metal.

15. A heat resistant metal member having an oxidation resistant alloy coating film produced on the surface of a metal substrate,
wherein said oxidation resistant alloy coating film is produced by embedding said metal substrate in a diffusion and penetration processing agent containing metal oxide, active metal and catalytic compound and carrying out heat treatment, so that said oxidation resistant alloy coating film contains the metal constituting said metal oxide and said active metal.
